(19) United States
(12) Patent Application Publication
(10) Pub. No.: US 2025/0236515 A1
(43) Pub. Date: Jul. 24, 2025

(54) METHODS AND SYSTEMS FOR HYDROGEN STORAGE

(71) Applicant: University of North Texas, Denton, TX (US)

(72) Inventor: Jose Perez, Denton, TX (US)

(21) Appl. No.: 19/032,687

(22) Filed: Jan. 21, 2025

Related U.S. Application Data
(60) Provisional application No. 63/622,774, filed on Jan. 19, 2024.

(51) Int. Cl. C01B 3/00; B01D 53/04; B82Y 30/00; B82Y 40/00

(52) U.S. Cl. CPC C01B 3/0021; B01D 53/0438; B01D 2253/102; B01D 2253/25; B01D 2253/304; B01D 2257/108; B01D 2259/812; B82Y 30/00; B82Y 40/00; C01B 2204/30; C01B 2204/32; C01P 2004/61; C01P 2004/62

(57) ABSTRACT

In one aspect, the disclosure relates to methods for hydrogen storage and a composition comprising hydrogenated graphene formed by the disclosed methods. In one aspect, the method comprises: irradiating a graphene sample with electrons at energies of about 1 keV to about 40 keV at about 1 atm of pressure, thereby forming hydrogenated graphene. Also disclosed herein is a method for releasing stored hydrogen, comprising heating a hydrogenated graphene sample formed by a method disclosed herein at a temperature of about 240° C. to about 300° C. Also disclosed herein is a system for hydrogenating graphene, comprising a graphene sample and an electron accelerator configured to irradiate the graphene sample with electrons in ambient air at about 1 atm of pressure. This abstract is intended as a scanning tool for purposes of searching in the particular art and is not intended to be limiting of the present disclosure.

### CROSS-REFERENCE TO RELATED APPLICATIONS

This application claims the benefit of and priority to U.S. Provisional Application No. 63/622,774, filed on Jan. 19, 2024, which is incorporated herein by reference in its entirety.

### STATEMENT ON FUNDING PROVIDED BY THE U.S. GOVERNMENT

This invention was made with Government support under contract DMR-2312436 awarded by the National Science Foundation. The Government has certain rights in the invention.

### BACKGROUND

Hydrogen is of interest as a sustainable energy resource because it is the most common element on earth and has a high energy per mass of about 120 MJ/kg. Current hydrogen storage methods involve pressurized gas cylinders and cryogenic tanks in which hydrogen is liquified at 21 K. However, these methods are expensive and can be dangerous if there is a leak. Solid-state storage involves using metal hydrides, complex hydrides, or carbon-based materials to store and release hydrogen through adsorption or absorption and desorption. It is considered a safer and more cost-effective alternative than the other two methods. Metal hydrides have the most significant capacity for hydrogen but require high temperatures to achieve hydrogen desorption and violently react when exposed to moisture. Carbon-based materials, such as carbon nanotubes and graphene, are of interest because of their potential for storing significant weight percentages of hydrogen due to their large surface areas. However, current techniques used to hydrogenate carbon-based materials can be dangerous to implement and introduce significant lattice damage to carbon lattices, limiting the number of hydrogenation cycles. Therefore, there is a need for methods and systems for hydrogen storage that are relatively safe relatively cost-effective. These needs and other needs are satisfied by the present disclosure.

### SUMMARY

In accordance with the purpose(s) of the disclosure, as embodied and broadly described herein, the disclosure, in one aspect, relates to methods and systems for hydrogen storage and compositions comprising hydrogenated graphene formed by the disclosed methods. In one aspect, the methods comprise: irradiating a graphene sample with electrons at energies of about 1 keV to about 40 keV at about 1 atm of pressure, thereby forming hydrogenated graphene. In on aspect, the systems comprise: a graphene sample and an electron accelerator configured to irradiate the graphene sample with electrons in ambient air at about 1 atm of pressure. Also disclosed herein is a method for releasing stored hydrogen, comprising heating a hydrogenated graphene sample formed by a method disclosed herein at a temperature of about 240° C. to about 300° C.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described aspects are usable in all aspects of the disclosure taught herein. Furthermore, the individual features of the dependent claims, as well as all optional and preferred features and modifications of the described aspects are combinable and interchangeable with one another.

### BRIEF DESCRIPTION OF THE FIGURES

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1A shows Raman spectra and I_{D}/I_{G} ratios of graphene after electron irradiation using an SEM system. [24]

FIG. 1B shows a representative optical image of the sample disclosed herein, where “X”s represent locations over which the Raman spectra of FIG. 1A was averaged. [24]

FIG. 1C shows a representative plot of I_{D}/I_{G} versus total dosage Dₑ. [24]

FIG. 1D shows a representative plot of I_{D}/I_{G} versus 100/√Dₑ, where solid squares represent data points from FIG. 1A and the solid curve is a fit using a two-stage model depicted in the inset. [24]

FIGS. 2A-2B show a representative schematic illustrating the effect of initial adsorbed water coverage on I_{D}/I_{G} (FIG. 2A) and the defect density after irradiation (FIG. 2B), where the shaded regions are those having adsorbed water.

FIG. 3A shows a representative plot of I_{D}/I_{G} versus A/√Dₑ with A=100 for a different graphene sample, with the inset showing the FWHM of the 2D, G, and D peaks as a function of A/√Dₑ. [24]

FIG. 3B shows a representative Raman spectra of the sample in FIG. 3A after annealing at the specified temperatures. [24]

FIG. 3C shows a representative Arrhenius plot of the natural log of the fractional change in I_{D}/I_{G} versus 1/T. [24]

FIGS. 4A-4B show a representative optical image of graphene exfoliated onto an SiO₂/Si substrate with etched holes 1 and 2 and a flake over the holes (FIG. 4A) and a close-up of the same (FIG. 4B), where “X”, “*”, and “□” denote locations where Raman spectra were acquired and the arrows indicated the monolayer (ML) region.

FIGS. 4C-4D show a representative SEM image of graphene exfoliated onto an SiO₂/Si substrate with etched holes 1 and 2 and a flake over the holes (FIG. 4C) and a high-resolution SEM image of hole 2 (FIG. 4D), where the regular arrows indicate an SiO₂ region darkened due to charging from the imaging, the cross-base arrows indicate a channel etched into the SiO₂ substrate through which air escapes, and the dashed line indicates the boundary of the flake.

FIGS. 5A-5B show representative Raman spectra of suspended graphene (FIG. 5A) and graphene on SiO₂ (FIG. 5B) after electron irradiation using SEM at 20 keV to a dosage of 2.4×10¹⁷ e⁻/cm² and after annealing.

FIG. 5C shows a representative Arrhenius plot of the natural log of the fractional change in I_{G}/I_{D} versus 1/T.

FIG. 6 shows a comparison of the I_{G}/I_{D} ratio of the representative graphene monolayer over hole 1 depicted in FIGS. 4A-4C containing an atmosphere of air and hole 2 depicted in FIGS. 4A-4D containing a vacuum.

FIG. 7 shows representative Raman spectra of graphene before electron irradiation (spectrum (a)) and after electron irradiation (spectrum (b)) using SEM at 30 keV to a dosage of 5.2×10¹⁷ e⁻/cm², after annealing (spectrum (c)) at 270° C. for 30 minutes, and after heating (spectrum (d)) at 590° C. in UHV for 1 h and irradiation at 5 keV to 7.4×10¹⁵ e⁻/cm². [7]

FIG. 8 shows representative Raman spectra of graphene samples that are heated in UHV at 590° C., exposed to the indicated gas at room temperature, and then irradiated at 5 keV in UHV. [8]

FIGS. 9A-9D show XPS spectra of various representative CVD-grown graphene samples.

FIG. 10A shows a representative fabricated suspended graphene sample without electrical contacts where the graphene is deposited over pre-existing etched trenches that are 5 μm wide and several hundred nanometers deep.

FIG. 10B shows the representative fabricated suspended graphene samples of FIG. 10A used for Raman spectroscopy and mechanical studies using AFM.

FIG. 11A shows a representative fabricated suspended graphene sample where the graphene is exfoliated or transferred onto an SiO₂ substrate and gold contacts are deposited using EBL.

FIG. 11B shows the representative substrate of FIG. 11A after being dipped in BOE, which removes the SiO₂ everywhere, except under the gold contacts.

FIG. 11C shows a setup of the representative substrate of FIG. 11B to measure electrical conductivity and photoconductivity.

FIG. 11D shows a setup of the representative substrate of FIG. 11B to thermally desorb adsorbates from a single graphene sample.

FIG. 12 shows a schematic of a representative electron accelerator, where the electrons exit through the Si₃N₄ window into air.

Additional advantages of the disclosure will be set forth in part in the description which follows, and in part will be obvious from the description, or can be learned by practice of the disclosure. The advantages of the disclosure will be realized and attained by means of the elements and combinations particularly pointed out in the appended claims. It is to be understood that both the foregoing general description and the following detailed description are exemplary and explanatory only and are not restrictive of the disclosure, as claimed.

### DETAILED DESCRIPTION

This disclosure is not limited to particular embodiments described, and as such may, of course, vary. The terminology used herein serves the purpose of describing particular embodiments only, and is not intended to be limiting, since the scope of the present disclosure will be limited only by the appended claims.

Where a range of values is provided, each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Before the embodiments of the present disclosure are described in detail, it is to be understood that, unless otherwise indicated, the present disclosure is not limited to particular materials, reagents, reaction materials, manufacturing processes, dimensions, frequency ranges, applications, or the like, as such can vary. It is also to be understood that the terminology used herein is for purposes of describing particular embodiments only, and is not intended to be limiting. It is also possible in the present disclosure that steps can be executed in different sequence, where this is logically possible. It is also possible that the embodiments of the present disclosure can be applied to additional embodiments involving measurements beyond the examples described herein, which are not intended to be limiting. It is furthermore possible that the embodiments of the present disclosure can be combined or integrated with other measurement techniques beyond the examples described herein, which are not intended to be limiting.

It should be noted that, as used in the specification and the appended claims, the singular forms “a,” “an,” and “the” include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1 percent to about 5 percent” should be interpreted to include not only the explicitly recited concentration of about 0.1 weight percent to about 5 weight percent but also include individual concentrations (e.g., 1 percent, 2 percent, 3 percent, and 4 percent) and the sub-ranges (e.g., 0.5 percent, 1.1 percent, 2.2 percent, 3.3 percent, and 4.4 percent) within the indicated range. The term “about” can include traditional rounding according to significant figures of the numerical value. In addition, the phrase “about ‘x’ to ‘y’” includes “about ‘x’ to about ‘y’”.

Each of the applications and patents cited in this text, as well as each document or reference cited in each of the applications and patents (including during the prosecution of each issued patent; “application cited documents”), and each of the PCT and foreign applications or patents corresponding to and/or claiming priority from any of these applications and patents, and each of the documents cited or referenced in each of the application cited documents, are hereby expressly incorporated herein by reference. Further, documents or references cited in this text, in a Reference List before the claims, or in the text itself; and each of these documents or references (“herein cited references”), as well as each document or reference cited in each of the herein-cited references (including any manufacturer's specifications, instructions, etc.) are hereby expressly incorporated herein by reference.

Prior to describing the various embodiments, the following definitions are provided and should be used unless otherwise indicated.

### A. DEFINITIONS

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.”

As used herein, the term “and/or” includes any and all combinations of one or more of the associated listed items. Expressions such as “at least one of,” when preceding a list of elements, modify the entire list of elements and do not modify the individual elements of the list.

Compounds of the disclosure can be prepared using reactions and methods generally known to the person of ordinary skill in the art, having regard to that knowledge and the disclosure of this application including the Examples. The reactions are performed in solvent appropriate to the reagents and materials used and suitable for the reactions being effected. It will be understood by those skilled in the art of organic synthesis that the functionality present on the compounds should be consistent with the proposed reaction steps. This will sometimes require modification of the order of the synthetic steps or selection of one particular process scheme over another in order to obtain a desired compound of the disclosure. It will also be recognized that another major consideration in the development of a synthetic route is the selection of the protecting group used for protection of the reactive functional groups present in the compounds described in this disclosure. An authoritative account describing the many alternatives to the skilled artisan is Greene and Wuts (Protective Groups In Organic Synthesis, Wiley and Sons, 1991).

Reference to “a” chemical compound refers to one or more molecules of the chemical compound rather than being limited to a single molecule of the chemical compound. Furthermore, the one or more molecules may or may not be identical, so long as they fall under the category of the chemical compound. Thus, for example, “a” chemical compound is interpreted to include one or more molecules of the chemical, where the molecules may or may not be identical (e.g., different isotopic ratios, enantiomers, and the like).

As used herein, “ambient air” refers to atmospheric air in its natural state, typically comprising about 78% nitrogen, 21% oxygen, and small amounts of other gases. Unless otherwise noted, the relative humidity of ambient air can range from about 5% to about 100%. In one aspect, ambient air refers to air in its natural state at room temperature (about 18° C. to about 24° C.) and about 40% relative humidity.

Unless otherwise specified, temperatures referred to herein are based on atmospheric pressure (i.e. one atmosphere). Standard temperature and pressure (STP) are defined as 20° C. and 1 atmosphere.

### B. ABBREVIATIONS

AFM atomic force microscopy
BOE buffered oxide etch
CVD chemical vapor deposition
EBL electron-beam lithography
ESEM environmental scanning electron microscopy
FWHM full-width-at-half-maxima
SEM scanning electron microscopy
STM scanning tunneling microscopy
STP standard temperature and pressure
STS scanning tunneling spectroscopy
TEM transmission electron microscopy
TPD temperature programmed desorption
UHV ultrahigh vacuum
XPS X-ray photoelectron spectroscopy

### C. DISCUSSION

The present disclosure provides for methods and systems for hydrogen storage, including hydrogenating graphene. In some aspects, a method for releasing the stored hydrogen is also provided. The method for storing hydrogen is simple, safe, and commercially viable compared to other strategies of hydrogen storage.

Hydrogen is of interest as a sustainable energy resource because it is the most common element on earth and has a high energy per mass of about 120 MJ/kg. Current hydrogen storage methods involve pressurized gas cylinders and cryogenic tanks in which hydrogen is liquified at 21 K. However, these methods are expensive and can be dangerous if there is a leak. Solid-state storage, considered a safer and more cost-effective alternative, involves using metal hydrides, complex hydrides, or carbon-based materials to store and release hydrogen through adsorption or absorption and desorption. Metal hydrides have the most significant capacity for hydrogen but require high temperatures to achieve hydrogen desorption and violently react when exposed to moisture. Alternatively, carbon nanotubes (CNTs) and graphene have been the most studied because of their potential for storing significant wt % of hydrogen due to their large surface areas. Graphene is better than CNTs because it is cheaper than CNTs, has a lower desorption temperature, and does not contain toxic metallic nanoparticles used to produce CNTs. Previous attempts at hydrogenating graphene have typically only achieved hydrogen levels of 30-40% due to the low partial pressures of hydrogen, and vacancies form due to the high kinetic energies of the plasma species. A method for achieving higher levels of hydrogenation is needed.

The method disclosed herein includes preparing a graphene sample and hydrogenating the graphene sample by irradiating it with electrons at energies of about 1 keV to about 40 keV at about 1 atm of pressure or about 0.9 atm to about 1.1 atm of pressure. In other aspects, the graphene sample can be irradiated with electrons at energies of about 1 keV to about 30 keV, about 1 keV to about 25 keV, about 1 keV to about 20 keV, about 5 keV to about 20 keV, about 10 keV to about 25 keV, about 15 keV to about 25 keV, or about 20 keV. The electron irradiation can be performed using an electron accelerator. In further aspects, the graphene sample is irradiated at a temperature of about 0° C. to about 40° C., about 10° C. to about 30° C., or about 15° C. to about 25° C. In other aspects, the graphene sample is irradiated at near room temperature, or about 18° C. to about 24° C. In other aspects, the graphene sample is irradiated at near standard temperature and pressure (STP), i.e., about 1 atm and about 20° C. The graphene sample can be irradiated in ambient air. In some aspects, the ambient air has a relative humidity of about 10% to about 90%, about 20% to about 80%, about 20% to about 60%, about 30% to about 50%, or about 40%.

Preparing the graphene sample can include depositing at least one graphene layer onto a support (e.g., a silicon substrate such as SiO₂/Si or a mica substrate) so that at least one surface of the graphene layer is exposed to air and a second surface of the graphene layer is at least partially in contact with the support. The support can be configured so that part of the second surface of the graphene layer is also exposed to air. In some aspects, when the support is a substrate, the substrate includes at least one trench that the graphene is deposited over, so that at least a portion of the graphene is suspended over the trench and part of the second surface of the graphene layer is exposed to air. The trench in the substrate can have a length and/or width of about 1 μm to about 15 μm, about 1 μm to about 10 μm, about 1 μm to about 7 μm, or about 1 μm to about 5 μm. The trench can have a depth of about 100 nm to about 1000 nm, about 100 nm to about 500 nm, about 100 nm to about 400 nm, or about 100 nm to about 300 nm. In other aspects, the support is a transmission electron microscopy grid.

In other aspects, the sample of graphene includes graphene powder. Graphene powder can include single-layer or multi-layer graphene flakes not supported on a substrate. In one aspect, the graphene powder flakes have flake lengths from about 100 nm to about 10 μm. Graphene powder can be made via a chemical and/or a mechanical exfoliation of bulk graphite powder followed by a reduction of any graphene oxide present in the exfoliated graphene.

The ratio of the Raman D peak density (I_{D}) to the Raman G peak density (I_{G}) in graphene has been observed to increase linearly as the defect density in a graphene sample increases, provided the defects do not significantly overlap. Therefore, it is possible to relate the extent of hydrogen coverage in hydrogenated graphene to the I_{D}/I_{G} ratio. In some aspects, the method of hydrogenating graphene produces graphene with an I_{D}/I_{G} ratio of at least about 1.0, as measured by Raman spectroscopy. In other aspects, the I_{D}/I_{G} ratio of the hydrogenated graphene can be at least about 1.0, at least about 2.0, at least about 3.0, at least about 4.0, at least about 5.0, at least about 6.0, at least about 7.0, or at least about 8.0. In some aspects, the I_{D}/I_{G} ratio can be about 6.3. In some aspects, the I_{D}/I_{G} ratio can be at most about 9.0 or at most about 9.2. In another aspect, the I_{D}/I_{G} ratio can range from about 2.0 to about 9.0, bout 3.0 to about 9.0, about 4.0 to about 9.0, about 5.0 to about 9.0, about 6.0 to about 9.0, about 2.0 to about 8.0, about 2.0 to about 7.0, about 2.0 to about 6.0, about 3.0 to about 8.0, about 4.0 to about 8.0, or about 5.0 to about 8.0.

Following hydrogenation, the majority of the hydrogen can be released from the graphene sample (desorbed) by annealing or heating at low temperatures. In some aspects, the hydrogenated graphene sample can be annealed at temperatures of about 200° C. to about 300° C., about 220° C. to about 300° C., about 240° C. to about 300° C., about 250° C. to about 290° C., about 260° C. to about 280° C., or about 270° C. The sample can be annealed for at least 15 minutes, at least 30 minutes, at least one hour, or at least two hours. In other aspects, the sample is annealed for about 15 minutes to about one hour, about 15 minutes to about 45 minutes, about 30 minutes to about one hour, about 30 minutes to about 45 minutes, or about 30 minutes. In some aspects, the lattice of the graphene sample is not significantly altered by hydrogenation and desorption and can be used again for additional hydrogenation and desorption processes.

A system for hydrogenating graphene is also disclosed herein and includes a graphene sample (e.g., graphene powder as discussed herein) and electron accelerator configured to irradiate the graphene sample with electrons in ambient air at about 1 atm of pressure. In some aspects, the graphene sample is kept at a temperature of about 0° C. to about 40° C. In other aspects, the graphene sample is kept near room temperature, or about 18° C. to about 24° C. In other aspects, the graphene sample is kept near standard temperature and pressure (STP), i.e., about 1 atm and about 20° C.

The graphene sample can include at least one layer of graphene deposited on a support (e.g., a silicon substrate such as SiO₂/Si or a mica substrate) so that at least one surface of the graphene layer is exposed to air and a second surface of the graphene layer is at least partially in contact with the support. The support can be configured so that part of the second surface of the graphene layer is also exposed to air. In some aspects, when the support is a substrate, the substrate includes at least one trench that the graphene is deposited over, so that at least a portion of the graphene is suspended over the trench and part of the second surface of the graphene layer is exposed to air. The trench in the substrate can have a length and/or width of about 1 μm to about 15 μm, about 1 μm to about 10 μm, about 1 μm to about 7 μm, or about 1 μm to about 5 μm. The trench can have a depth of about 100 nm to about 1000 nm, about 100 nm to about 500 nm, about 100 nm to about 400 nm, or about 100 nm to about 300 nm. In other aspects, the support is a transmission electron microscopy grid.

### D. REFERENCES

References are cited herein throughout using the format of reference number(s) enclosed by brackets corresponding to one or more of the following numbered references. For example, citation of references numbers 1 and 2 immediately herein below would be indicated in the disclosure as ([1,2]).
[1] Novoselov, K. S., Jiang, D., Schedin, F., Booth, T. J., Khotkevich, V. V., Morozov, S. V. and Geim, A. K., 2005. Two-dimensional atomic crystals. Proceedings of the National Academy of Sciences, 102 (30), pp. 10451-10453.
[2] Novoselov, K. S., Geim, A. K., Morozov, S. V., Jiang, D. E., Zhang, Y., Dubonos, S. V., Grigorieva, I. V. and Firsov, A. A., 2004. Electric field effect in atomically thin carbon films. Science, 306 (5696), pp. 666-669.
[3] Childres, I., Jauregui, L. A., Park, W., Cao, H. and Chen, Y. P., 2013. Raman spectroscopy of graphene and related materials. New Developments in Photon and Materials Research, 1, pp. 1-20
[4] Iqbal, M. Z., Kelekci, O., Iqbal, M. W. and Eom, J., 2013. The structural and electrical evolution of chemical vapor deposition grown graphene by electron beam irradiation induced disorder. Carbon, 59, pp. 366-371.
[5] Lucchese, M. M., Stavale, F., Ferreira, E. M., Vilani, C., Moutinho, M. V. D. O., Capaz, R. B., Achete, C. A. and Jorio, A., 2010. Quantifying ion-induced defects and Raman relaxation length in graphene. Carbon, 48 (5), pp. 1592-1597.
[6] Zhao, F., Raitses, Y., Yang, X., Tan, A. and Tully, C. G., 2021. High hydrogen coverage on graphene via low temperature plasma with applied magnetic field. Carbon, 177, pp. 244-251.
[7] Jones, J. D., Ecton, P. A., Mo, Y. and Perez, J. M., 2009. Comment on “Modification of graphene properties due to electron-beam irradiation” [Appl. Phys. Lett. 94, 013101 (2009)]. Applied Physics Letters, 95 (24), p. 013101.
[8] Jones, J. D., Mahajan, K. K., Williams, W. H., Ecton, P. A., Mo, Y. and Perez, J. M., 2010. Formation of graphane and partially hydrogenated graphene by electron irradiation of adsorbates on graphene. Carbon, 48 (8), pp. 2335-2340.
[9] Ridene, M., Najafi, A. and Flipse, K., 2019. Origin of room-temperature ferromagnetism in hydrogenated epitaxial graphene on silicon carbide. Nanomaterials, 9 (2), p. 228.
[10] González-Herrero, H., Gómez-Rodríguez, J. M., Mallet, P., Moaied, M., Palacios, J. J., Salgado, C., Ugeda, M. M., Veuillen, J. Y., Yndurain, F. and Brihuega, I., 2016. Atomic-scale control of graphene magnetism by using hydrogen atoms. Science, 352 (6284), pp. 437-441.
[11] Goler, S., Coletti, C., Tozzini, V., Piazza, V., Mashoff, T., Beltram, F., Pellegrini, V., Heun, S., 2013. The influence of graphene curvature on hydrogen adsorption: towards hydrogen storage devices. J. Phys. Chem. C 117, 11506-11513.
[12] Balog, R., Jørgensen, B., Wells, J., Lægsgaard, E., Hofmann, P., Besenbacher, F. and Hornekær, L., 2009. Atomic hydrogen adsorbate structures on graphene. Journal of the American Chemical Society, 131 (25), pp. 8744-8745.
[13] Eckmann, A., Felten, A., Mishchenko, A., Britnell, L., Krupke, R., Novoselov, K. S. and Casiraghi, C., 2012. Probing the nature of defects in graphene by Raman spectroscopy. Nano letters, 12 (8), pp. 3925-3930.
[14] Sofo, J. O., Chaudhari, A. S. and Barber, G. D., 2007. Graphane: A two-dimensional hydrocarbon. Physical Review B, 75 (15), p. 153401.
[15] Ryu, S., Han, M. Y., Maultzsch, J., Heinz, T. F., Kim, P., Steigerwald, M. L. and Brus, L. E., 2008. Reversible basal plane hydrogenation of graphene. Nano Letters, 8 (12), pp. 4597-4602.
[16] Elias, D. C., Nair, R. R., Mohiuddin, T. M. G., Morozov, S. V., Blake, P., Halsall, M. P., Ferrari, A. C., Boukhvalov, D. W., Katsnelson, M. I., Geim, A. K. and Novoselov, K. S., 2009. Control of graphene's properties by reversible hydrogenation: evidence for graphane. Science, 323 (5914), pp. 610-613.
[17] Klimov, N. N., Jung, S., Zhu, S., Li, T., Wright, C. A., Solares, S. D., Newell, D. B., Zhitenev, N. B. and Stroscio, J. A., 2012. Electromechanical properties of graphene drumheads. Science, 336 (6088), pp. 1557-1561.
[18] Bunch, J. S., Verbridge, S. S., Alden, J. S., Van Der Zande, A. M., Parpia, J. M., Craighead, H. G. and McEuen, P. L., 2008. Impermeable atomic membranes from graphene sheets. Nano Letters, 8(8), pp. 2458-2462.
[19] Boateng, E. and Chen, A., 2020. Recent advances in nanomaterial-based solid-state hydrogen storage. Materials Today Advances, 6, p. 100022.
[20] He, Q., Zeng, L., Han, L., Sartin, M. M., Peng, J., Li, J. F., Oleinick, A., Svir, I., Amatore, C., Tian, Z. Q. and Zhan, D., 2021. Electrochemical Storage of Atomic Hydrogen on Single Layer Graphene. Journal of the American Chemical Society, 143 (44), p. 18419-18425.
[21] Gledhill, J. A., 1973. The range-energy relation for 0.1-600 keV electrons. Journal of Physics A: Mathematical, Nuclear and General, 6(9), p. 1420.
[22] Vorobyov, M. S., Koval, T. V., Koval, N. N. and Hung, N. B., 2018. Generation, transport, and efficient extraction of a large cross-section electron beam into an air in an accelerator with a mesh plasma cathode. Laser and Particle Beams, 36(1), pp. 22-28.
[23] Whitener Jr, K. E., 2018. Hydrogenated graphene: A user's guide. Journal of Vacuum Science & Technology A: Vacuum, Surfaces, and Films, 36(5), p. 05G401.
[24] I. A. Ojo, E. Hathaway, R. R. Gonzales, P. R. Adhikari, V. Sathish, B. Kunam, Y. Khalid, J. Cui, W. Choi, and J. M. Perez, “Effects on graphene of electron irradiation at 25 keV and dosages up to 1018 electrons/cm2”, J. Vac. Sci. Technol. A., accepted for publication.
[25] Meyer, J. C., Eder, F., Kurasch, S., Skakalova, V., Kotakoski, J., Park, H. J., Roth, S., Chuvilin, A., Eyhusen, S., Benner, G. and Krasheninnikov, A. V., 2012. Accurate measurement of electron beam induced displacement cross sections for single-layer graphene. Physical review letters, 108 (19), p. 196102.
[26] Banhart, F., 1999. Irradiation effects in carbon nanostructures. Reports on progress in physics, 62 (8), p. 1181.
[27] Susi, T., Meyer, J. C. and Kotakoski, J., 2019. Quantifying transmission electron microscopy irradiation effects using two-dimensional materials. Nature Reviews Physics, 1(6), pp. 397-405.
[28] Teweldebrhan, D. and Balandin, A. A., 2009. Modification of graphene properties due to electronbeamirradiation. Applied Physics Letters, 94(1), p. 013101.
[29] Ferrari, A. C. and Robertson, J., 2000. Interpretation of Raman spectra of disordered and amorphous carbon. Physical review B, 61(20), p. 14095.
[30] Ferreira, E. M., Moutinho, M. V., Stavale, F., Lucchese, M. M., Capaz, R. B., Achete, C. A. and Jorio, A., 2010. Evolution of the Raman spectra from single-, few-, and many-layer graphene with increasing disorder. Physical Review B, 82(12), p. 125429.
[31] Cançado, L. G., Jorio, A., Ferreira, E. M., Stavale, F., Achete, C. A., Capaz, R. B., Moutinho, M. V. D. O., Lombardo, A., Kulmala, T. S. and Ferrari, A. C., 2011. Quantifying defects in graphene via Raman spectroscopy at different excitation energies. Nano Letters, 11(8), pp. 3190-3196.
[32] Islam, A. E., Susner, M. A., Carpena-Nuñez, J., Back, T. C., Rao, R., Jiang, J., Pachter, R., Tenney, S. A., Boeckl, J. J. and Maruyama, B., 2020. Defect engineering of graphene using electron-beam chemistry with radiolyzed water. Carbon, 166, pp. 446-455.
[33] Withers, F., Bointon, T. H., Dubois, M., Russo, S. and Craciun, M. F., 2011. Nanopatterning of fluorinated graphene by electron beam irradiation. Nano letters, 11(9), pp. 3912-3916.
[34] Lee, W. K., Whitener Jr, K. E., Robinson, J. T. and Sheehan, P. E., 2015. Patterning Magnetic Regions in Hydrogenated Graphene Via E-Beam Irradiation. Advanced Materials, 27 (10), pp. 1774-1778.
[35] Lan, Y. W., Chang, W. H., Xiao, B. T., Liang, B. W., Chen, J. H., Jiang, P. H., Li, L. J., Su, Y. W., Zhong, Y. L. and Chen, C. D., 2014. Polymer-Free Patterning of Graphene at Sub-10-nm Scale by Low-Energy Repetitive Electron Beam. Small, 10(22), pp. 4778-4784.
[36] Chen, J., Shi, T., Cai, T., Xu, T., Sun, L., Wu, X. and Yu, D., 2013. Self-healing of defected graphene. Applied Physics Letters, 102(10), p. 103107.
[37] Lau, D., Hughes, A. E., Muster, T. H., Davis, T. J. and Glenn, A. M., 2010. Electron-beam-induced carbon contamination on silicon: characterization using Raman spectroscopy and atomic force microscopy. Microscopy and Microanalysis, 16(1), pp. 13-20.
[38] Boukhvalov, D. W., 2010. Modeling of hydrogen and hydroxyl group migration on graphene. Physical Chemistry Chemical Physics, 12(47), pp. 15367-15371.
[39] J. Vac. Sci. Technol. A 39, 013204 (2021)
[40] Bolotin, K. I., Sikes, K. J., Jiang, Z., Klima, M., Fudenberg, G., Hone, J., Kim, P. and Stormer, H. L., 2008. Ultrahigh electron mobility in suspended graphene. Solid state communications, 146 (9-10), pp. 351-355.
[41] Sojoudi, H., Baltazar, J., Henderson, C., Graham, S., 2012. Impact of post-growth thermal annealing and environmental exposure on the unintentional doping of CVD graphene films. J. Vac. Sci. Technol. B 30, 041213.
[42] Peng, Q., Liang, C., Ji, W. and De, S., 2013. A theoretical analysis of the effect of the hydrogenation of graphene to graphane on its mechanical properties. Physical Chemistry Chemical Physics, 15(6), pp. 2003-2011.
[43] Ansari, R., Mirnezhad, M. and Rouhi, H., 2015. Mechanical properties of fully hydrogenated graphene sheets. Solid State Communications, 201, pp. 1-4.

### E. ASPECTS

The following listing of exemplary aspects supports and is supported by the disclosure provided herein.

Aspect 1. A method for hydrogen storage comprising: hydrogenating a graphene sample by irradiating the graphene sample with electrons at energies of about 1 keV to about 40 keV at about 1 atm of pressure.

Aspect 2. The method of aspect 1, wherein the graphene sample is irradiated at a temperature of about 0° C. to about 40° C.

Aspect 3. The method of aspect 1, wherein the graphene sample is irradiated at a temperature of about 18° C. to about 24° C.

Aspect 4. The method of aspect 1 or aspect 2, wherein the graphene sample is irradiated in ambient air.

Aspect 5. The method of any one of aspects 1-4, wherein the graphene sample is irradiated with electrons at energies of about 15 keV to about 25 keV.

Aspect 6. The method of any one of aspects 1-5, wherein the graphene sample is irradiated with electrons using an electron accelerator.

Aspect 7. The method of any one of aspects 1-6, wherein the graphene sample comprises at least one graphene layer deposited onto a support so that at least one surface of the graphene layer is exposed to air and a second surface of the graphene layer is at least partially in contact with the support.

Aspect 8. The method of aspect 7, wherein the support is configured so that at least part of the second surface of the graphene layer is exposed to air.

Aspect 9. The method of aspect 7 or 8, wherein the support is a silicon substrate.

Aspect 10. The method of aspect 7 or 8, wherein the support is an SiO₂/Si substrate.

Aspect 11. The method of aspect 7 or 8, wherein the support is a mica substrate.

Aspect 12. The method of any one of aspects 7-11, wherein the support comprises at least one trench of about 1 to about 10 μm in width and about 100 to about 500 nm in depth and wherein the graphene layer is deposited over the trench so that at least part of the second surface of the graphene layer is exposed to air.

Aspect 13. The method of any one of aspects 1-12, wherein the graphene sample comprises graphene powder.

Aspect 14. The method of aspect 13, wherein the graphene powder has a flake size of about 100 nm to about 10 μm.

Aspect 15. The method of any one of aspects 1-14, wherein the hydrogenated graphene has an I_{D}/I_{G} ratio of greater than about 2.0 as measured by Raman spectroscopy.

Aspect 16. The method of any one of aspects 1-14, wherein the hydrogenated graphene has an I_{D}/I_{G} ratio of greater than about 4.0 as measured by Raman spectroscopy.

Aspect 17. A method for releasing stored hydrogen, comprising heating the hydrogenated graphene of any one of aspects 1-16 at a temperature of about 240° C. to about 300° C.

Aspect 18. The method of aspect 17, wherein the hydrogenated graphene is heated at a temperature of about 270° C.

Aspect 19. The method of aspect 17 or aspect 18, wherein the hydrogenated graphene is heated for about 15 minutes to about one hour.

Aspect 20. A system for hydrogenating graphene, comprising a graphene sample and an electron accelerator configured to irradiate the graphene sample with electrons in ambient air at about 1 atm of pressure.

Aspect 21. The system of aspect 20, wherein the graphene sample is kept at a temperature of about 0° C. to about 40° C.

Aspect 22. The system of aspect 20 or aspect 21, wherein the graphene sample comprises at least one layer of graphene deposited on a support so that at least one surface of the graphene layer is exposed to air and a second surface of the graphene layer is at least partially in contact with the support.

Aspect 23. The system of aspect 22, wherein the support is configured so that at least part of the second surface of the graphene sample is exposed to air.

Aspect 24. The system of aspect 22 or 23, wherein the support is a silicon substrate.

Aspect 25. The system of aspect 22 or 23, wherein the support is an SiO₂/Si substrate.

Aspect 26. The system of aspect 22 or 23, wherein the support is a mica substrate.

Aspect 27. The system of any one of aspects 22-26, wherein the support comprises at least one trench of about 1 to about 10 μm in width and about 100 to about 500 nm in depth and wherein the graphene layer is deposited over the trench so that at least part of the second surface of the graphene sample is exposed to air.

Aspect 28. The system of any one of aspects 20-27, wherein the graphene sample comprises graphene powder.

Aspect 29. A composition comprising graphene hydrogenated by the method of any one of aspects 1-16.

From the foregoing, it will be seen that aspects herein are well adapted to attain all the ends and objects hereinabove set forth together with other advantages which are obvious and which are inherent to the structure.

While specific elements and steps are discussed in connection to one another, it is understood that any element and/or steps provided herein is contemplated as being combinable with any other elements and/or steps regardless of explicit provision of the same while still being within the scope provided herein.

It will be understood that certain features and subcombinations are of utility and may be employed without reference to other features and subcombinations. This is contemplated by and is within the scope of the claims.

Since many possible aspects may be made without departing from the scope thereof, it is to be understood that all matter herein set forth or shown in the accompanying drawings and detailed description is to be interpreted as illustrative and not in a limiting sense.

It is also to be understood that the terminology used herein is for the purpose of describing particular aspects only, and is not intended to be limiting. The skilled artisan will recognize many variants and adaptations of the aspects described herein. These variants and adaptations are intended to be included in the teachings of this disclosure and to be encompassed by the claims herein.

Now having described the aspects of the present disclosure, in general, the following Examples describe some additional aspects of the present disclosure. While aspects of the present disclosure are described in connection with the following examples and the corresponding text and figures, there is no intent to limit aspects of the present disclosure to this description. On the contrary, the intent is to cover all alternatives, modifications, and equivalents included within the spirit and scope of the present disclosure.

### F. EXAMPLE 1

Introduction. Herein is discussed the hydrogenation of two-dimensional (2D) graphene [1,2] using electron irradiation in the energy range of 1-30 keV under air at near-atmospheric pressure. Preliminary results on suspended mechanically exfoliated graphene irradiated under such conditions show an extremely high ratio of the Raman D peak intensity, I_{D}, to the Raman Gpeak intensity, I_{G}, of I_{D}/I_{G}=5.3. The I_{D}/I_{G} ratio in graphene increases linearly as the defect density increases when the defects have not significantly overlapped [3,4]. This value of I_{D}/I_{G} is considerably larger than the maximum of 3.3 reported for electron [3] and Ar ion [5] irradiation of supported graphene on SiO₂ in a vacuum and plasma-hydrogenated graphene [6]. Therefore, the preliminary results suggest electron irradiation at near-atmospheric pressure may increase the defect density by about 1.6. Previous reports on electron irradiation in a vacuum using an SEM system of exfoliated graphene supported on SiO₂ showed evidence that the defects produced by the irradiation are hydrogen adsorbates [7,8]. The hydrogenation can be attributed to the electron-induced dissociation of adsorbed water molecules on graphene. The irradiation of suspended graphene at near-atmospheric pressure may also result in the dissociation of adsorbed water and the hydrogenation of graphene. In that case, the high I_{D}/I_{G} ratios observed may imply that this irradiation method may result in high hydrogen coverages that would be useful for hydrogen storage and other applications. One objective is to determine the identity and density of the defects in the graphene irradiated at near-atmospheric pressure and investigate the properties of this material. Adsorbed hydrogen is not directly identifiable using XPS because hydrogen does not have core electrons, and its photoemitted electrons do not have signature energies. Indirect identification is possible by deconvolution of the spectra but is not definitive. Using temperature-programmed desorption to detect hydrogen from small, exfoliated samples or small irradiated areas, as we propose, requires significant care to ensure the observed hydrogen is from the graphene, not the surrounding area. These challenges are addressed by using the following techniques to identify the following defects: (1) STM and STS to directly probe for adsorbed hydrogen, as described in Refs. [9-12]. (2) Irradiation in a heavy water vapor environment to label with deuterium the resulting adsorbates. Then, the adsorbates will be identified using thermal desorption and mass spectroscopy and outgassing from surrounding areas will be significantly reduce by heating only the irradiated sample. (3) Raman spectroscopy of irradiated samples to help determine the defects' identity, such as by the I_{D}/I_{G} ratio, where I_{D′} is the intensity of the D′ peak, and G peak shifts, as described in Ref. [13].

Suspended graphene irradiated at near-atmospheric pressure recovers its low value of I_{D}/I_{G} after annealing at 280° C. Thus, irradiation at near-atmospheric pressure may produce high adsorbate densities with minor lattice damage. If the defects are hydrogen adsorbates, the hydrogen could be desorbed at relatively low temperatures. The hydrogenation would be repeatable since desorption does not significantly damage the graphene lattice. In addition to hydrogen storage, irradiated graphene may have valuable mechanical, electrical, and optical properties. For example, fully hydrogenated graphene, called graphane, has been predicted to have a direct band gap of about 3.5 eV [14-16]. The proposed experiments herein will include supported and suspended graphene produced by mechanical exfoliation and CVD, and graphene grown on SiC substrates. In addition to the previously described techniques to detect adsorbed hydrogen, XPS will be used to complement the methods mentioned earlier, AFM will be used to study the mechanical properties, and current versus voltage and photoconductivity measurements will be used to study the electrical and optical properties.

Preliminary results on electron irradiation of suspended graphene at near-atmospheric pressure used graphene exfoliated over micron-sized holes etched into a SiO₂/Si substrate and high-vacuum SEM at 10-6 Torr. The exfoliation was in the air under standard temperature and pressure (STP) conditions. Graphene samples that covered a hole called graphene drums [17,18] were irradiated. In such structures, the graphene seals the air molecules inside the cavity [18], maintaining near-atmospheric pressure when the substrate is in a vacuum. The samples were placed in the SEM system and irradiated. As discussed in this Example, the pressure in the covered holes is about 0.96 atmospheres after the sample is an hour in a vacuum. This pressure is referred to as near-atmospheric or atmospheric pressure. In this sample configuration, the graphene side facing the hole is exposed to air at near-atmospheric pressure, while the other side is under vacuum.

In the proposed experiments, graphene suspended over trenches so that both sides of the graphene can be at high pressure will be used. The sample will be contacted with electrical leads to allow for ohmic heating of only the irradiated sample to study thermal desorption. An ESEM system will be used, operating up to 20 Torr of heavy water vapor during irradiation with sample cooling and heating capabilities. The sample cooling will allow the density of adsorbed heavy water molecules at 20 Torr to reach or exceed that at atmospheric pressure. Since heavy water has the same electronic bonding as water, irradiation can be expected to cause similar reactions, including heavy water dissociation and deuterium adsorption. A mass spectrometer in the ESEM chamber and an UHV surface analysis system will detect desorbed deuterium as the graphene is heated. Since the mass of deuterium is twice that of hydrogen, the deuterium will be distinguishable from the background hydrogen gas produced by the hot tungsten filament of the mass spectrometer and stainless steel of the ESEM and UHV chambers. The mass spectrometer detects atomic hydrogen (H), H₂, atomic deuterium (D), and D₂ that have atomic masses of 1, 2, 2, and 4, respectively. Since there is no helium in the chamber, the atomic mass of four will mainly be due to D₂. We will use known cracking ratios in the mass spectrometer of H₂ to H and D₂ to D to quantify the amount of desorbed deuterium.

The UHV surface analysis system contains an STM system to be used for atomic-resolution imaging and STS of adsorbates. STS determines the density of states by measuring the tunneling current's dependence on the tip-sample voltage. Hydrogenation of graphene produces a gap in the density of states that increases with hydrogen coverage and is observable using STS [11]. In Ref. [11], the authors did the STM imaging and STS at room temperature (RT), so these STM studies will be at RT. The gaps in the density of states were on the order of an eV. The surface analysis system is attached to a multi-purpose sample preparation chamber. Graphene samples will be exposed to heavy water vapor in the preparation chamber and the graphene transferred to the surface analysis system using linear translators for electron irradiation, STM, STS, and mass spectrometry without contaminating the samples by exposure to air.

One of the methods currently used to hydrogenate graphene is exposure to hydrogen plasma [6]. A recent report on graphene hydrogenation using hydrogen plasma correlated the hydrogen coverage, as measured using XPS, with the I_{D}/I_{G} ratio and found that the hydrogen coverage increases linearly with I_{D}/I_{G} [6]. The maximum coverage reported was 35.8%, with I_{D}/I_{G}=3.3. One of the limitations of plasma exposure is that achieving high hydrogen coverages requires long exposure times, which increases vacancy density. Since the density of adsorbed molecules on a surface can typically be much higher than the aerial density of species in a plasma, irradiating graphene at near-atmospheric pressure may produce higher hydrogen coverages than possible using a plasma. If it is assumed that the hydrogen coverage continues to increase linearly with I_{D}/I_{G} past the reported coverage of 35.8% at I_{D}/I_{G}=3.3 in Ref. [6], then at the observed I_{D}/I_{G}=5.3, the hydrogen coverage would be 57.5%, assuming defects have not significantly overlapped. This coverage represents about 4.4 wt % of hydrogen, comparable to the Department of Energy's target of 4.5 wt % hydrogen storage by 2020 [19]. The preliminary results are for suspended graphene irradiated with only one side facing atmospheric pressure. If both sides of the graphene are at atmospheric pressure, as proposed, it might achieve a higher weight percentage of hydrogen [20]. Below is discussed a model describing the effects of irradiation on the I_{D}/I_{G} ratio that will use to estimate the hydrogen coverage from the I_{D}/I_{G} ratio.

The proposed method has the potential to produce hydrogen from H₂O, store it, and allow the release of stored hydrogen by heating at low temperatures. Extending the proposed methods to large-scale commercial applications is feasible. The mean free path of electrons in the air at STP is about 1 cm at 20 keV and increases exponentially with energy up to 1 MeV [21]. Commercial electron accelerators can shoot large cross-section (102-104 cm²) electron beams into the air and are used in applications such as sterilizing medical devices, air purification, cross-linking of polymers, and excitation sources for lasers. Such electron accelerators could irradiate bulk quantities of graphene powder in air at STP. A 20 keV electron gun that shoots an electron beam with a cross-section of 4 mm² into the air will be used to investigate the irradiation of bulk graphene powder in the air at STP.

Carbon nanotubes (CNTs) and graphene have been the most studied carbon-based materials for hydrogen storage because of their potential for storing significant weight percentages of hydrogen due to their large surface areas. However, graphene is better than CNTs because it is cheaper than CNTs, has a lower desorption temperature, and does not contain toxic metallic nanoparticles used to produce CNTs. As discussed, plasma exposure of graphene typically achieves only 30-40% hydrogenation due to the low partial pressures of hydrogen, and vacancies form due to the high kinetic energies of the plasma species. Other techniques used to hydrogenate graphene are direct exposure to atomic hydrogen, dissolving metal reduction, and electrochemical reduction [23]. The latter two methods can be used on bulk quantities of graphene but can be dangerous to implement and introduce significant lattice damage limiting the number of hydrogenation cycles.

Model of the Effect of Irradiation on the I_{D}/I_{G} Ratio. The following is from Ref. [24]. The effect of irradiation with electrons at 1-30 keV on supported graphene and its I_{D}/I_{G} ratio has been an area of interest because SEM and EBL operate at these energies. These energies are below the threshold for electrons to cause vacancies in graphene by elastic collisions with carbon atoms. The displacement threshold energy of carbon atoms in graphene is about 20 eV [25]. At 25 keV, the maximum kinetic energy an electron can elastically transfer to a carbon atom is <5 eV, so vacancy formation is unlikely [26]. Inelastic processes such as ionization are also unlikely to produce significant lattice damage because of the high velocity of the incident electrons and graphene's high electrical conductivity [27]. Electron irradiation likely has a more considerable influence on adsorbates than on the carbon lattice. The adsorbates may turn into radicals due to electronic excitations by the incident electrons, and the radicals may bind to the graphene lattice.

Although the energies are below the threshold for vacancy formation, previous studies have shown that irradiation at dosages used in SEM imaging and EBL results in the appearance of a Raman D peak [3,4,28], which is an indicator of defect formation. These authors reported that I_{D}/I_{G} follows the two-stage trajectory for carbon amorphization proposed by Ferrari and Robertson to explain the I_{D}/I_{G} ratio in disordered and amorphous carbon. Ferrari et al. observed this trajectory in graphene bombarded with Ar ions and developed an equation for I_{D}/I_{G} as a function of L_{D}, the distance between defects [5,30]. This model explains the observed behavior for Ar ion bombardment in which I_{D}/I_{G} increases with increasing dosage as new defects form that activate the D peak. In the second stage, the disordered regions overlap the active regions, decreasing I_{D}/I_{G}. This equation also models the behavior of I_{D}/I_{G} in graphene irradiated with electrons using an Ferrari authors reported that significant broadening of the D and G peaks occurred in the second stage and concluded the graphene becomes amorphous [5,30,31]. Vacancies introduce much bond disorder, and as their density increases, it is reasonable to conclude that the lattice becomes amorphous. In the case of electron irradiation, authors reported that graphene also becomes amorphous in the second stage [3,4]. They concluded this because the I_{D}/I_{G} ratio follows the two-stage trajectory. However, the nature of the defects, in this case, is not well known.

In contrast, other authors have reported that electron irradiation of graphene at these energies produces reversible functional modifications, such as the adsorption of hydrogen and the formation of sp3-type epoxide defects [32]. Hydrogen adsorption was observed by coating the samples with hydrogen silsesquioxane (HSQ) and irradiating them in an SEM system [15]. Electron irradiation at these energies can also change the transport properties of fluorinated graphene [33], produce magnetic regions in hydrogenated graphene [34], and etch graphene by repetitive exposure [35]. It was also previously reported that as-exfoliated graphene irradiated at 5 keV in UHV to a dosage of 1×10¹⁶ electrons/cm² develops a D peak that disappears after annealing the sample at 270° C. [8]. In addition, it was reported that graphene pre-annealed at 590° C. in UHV to remove adsorbates and then irradiated in situ does not develop a D peak. However, graphene pre-annealed in UHV and then exposed in situ to H₂O, NH₃, O₂, N₂, and CO₂ gases before irradiation does develop a D peak when exposed to H₂O or NH₃, but not when exposed to O₂, N₂ or CO₂. These results show that exposure of graphene to polar or hydrogen-containing gasses may be essential in producing the D peak. In a recent paper [24], irradiated graphene was thermally annealed and, based on the activation energy for defect healing, it was concluded that the defects are more likely hydrogen adsorbates or hydroxyl groups with attached water molecules than vacancies [36]. The two-stage model is also valid for electron irradiation because the adsorbates break the translational symmetry, increasing and decreasing I_{D}/I_{G} at high densities. However, the adsorbates do not damage the carbon lattice and produce amorphization. The model's applicability to electron irradiation will allow estimation of the amount of hydrogenation from the I_{D}/I_{G} ratio.

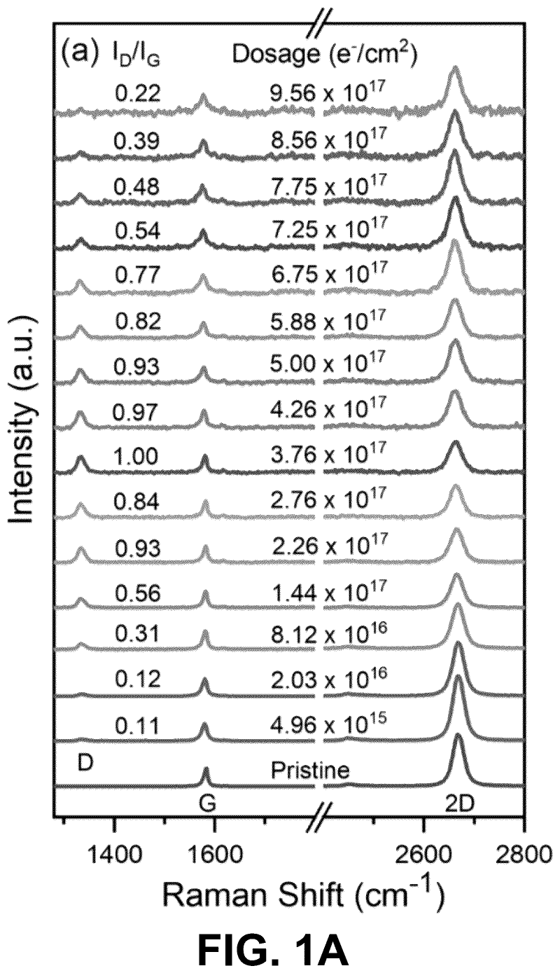

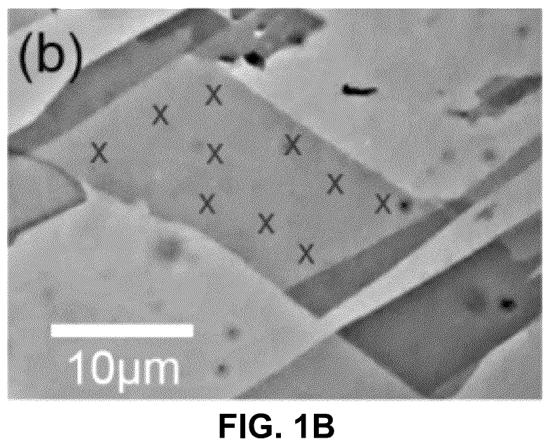

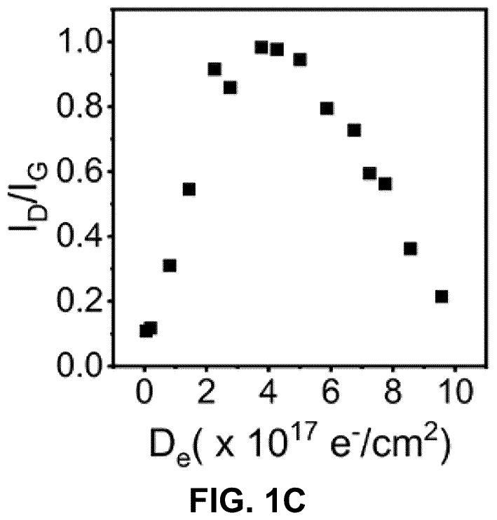

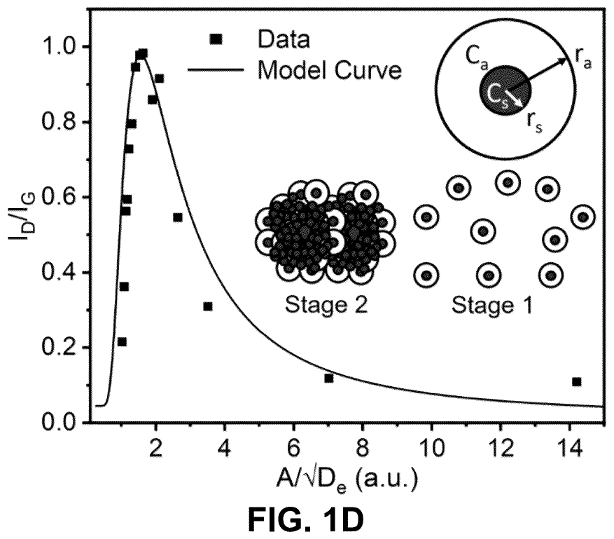

The graphene samples in were mechanically exfoliated from highly oriented-pyrolytic graphite (HOPG) using the scotch tape method in the air under ambient conditions on solid SiO₂/Si substrates. The facilities used for sample fabrication and characterization are similar to those discussed in this Example. FIG. 1A shows Raman spectra of a graphene sample irradiated to total dosages Dₑ from 4.96×10¹⁵-9.56×10¹⁷ electrons/cm². Each spectrum is an average of spectra collected at ten points, as indicated in FIG. 1B. Note that the signal-to-noise (S/N) ratio of the spectra decreases with increasing dosage. The decrease in S/N is due to an increase in background signal from the fluorescence of a thin 10 nm carbonaceous film that deposits during irradiation [37]. The fluorescence does not interfere with the measurement of the Raman lines from the graphene. FIG. 1C shows a plot of I_{D}/I_{G} versus Dₑ obtained from the experimental data. A knowledge of L_{D} after each dosage is needed to compare the experimental data with the two-stage model. Following Ref. [3], L_{D} is approximated by the expression A/√Dₑ, where A is a constant. The density, σ, of defects produced by the irradiation is proportional to Dₑ, i.e., σ=BDₑ. Additionally, L_{D}²=I/σ, and therefore L_{D}=A/√Dₑ, where A=1/B. A² is the number of electrons necessary to produce a defect that activates the D peak. FIG. 1D shows a plot of I_{D}/I_{G} versus A/√Dₑ, where A=100. The solid curve fits the data using the I_{D}/I_{G} versus L_{D} equation derived from the two-stage model [5,30]. Following Ref. [3], A=100 was chosen so that the maximum of I_{D}/I_{G} occurs at L_{D}=1.6-2.0 nm. L_{D}≈2 nm is the theoretically expected value for the maximum I_{D}/I_{G}, separating the first and second stages [29].

In the two-stage model, one models the defect sites and associated structural disorders by two regions [3-5]. There is a circular region of radius rₛ in which the graphene is structurally disordered, as shown in red in the inset in FIG. 1D. Surrounding the disordered region is a crystalline circular region of radius rₐ. The breathing mode giving rise to the D peak is allowed in the crystalline region due to its proximity to the disordered region. The constants Cₐ and Cₛ describe the contributions to I_{D}/I_{G} of the active and the disordered regions, respectively. In the first stage of the model, there are few defects, L_{D}>>rₐ, and the total D-peak active area increases as the density of disordered areas increases; therefore, I_{D}/I_{G} increases. At the onset of the second stage, the density of disordered areas is so high that as their density increases, the disordered regions overlap with active regions, and I_{D} decreases. The D peak is due to a breathing mode and requires crystalline regions of intact hexagonal sp²-bonded rings of about 2 nm in lateral dimension [29]. Since the disordered areas have only a few intact rings, they produce a low I_{D}. However, the G peak is due to the relative motion of adjacent carbon atoms, and I_{G} is not as affected by the lack of complete rings [29]. Consequently, in the second stage, I_{D}/I_{G} decreases.

Based on this model, the equation for I_{D}/I_{G} versus L_{D} is [5,30]:

$$\frac{{I}_{D}}{{I}_{G}} ( {L}_{D} ) = {C}_{a} \frac{{r}_{a}^{2} - {r}_{s}^{2}}{{r}_{a}^{2} - 2 {r}_{s}^{2}} [ {e}^{- \frac{π {r}_{s}^{2}}{{L}_{D}^{2}}} - {e}^{- \frac{π ( {r}_{a}^{2} - {r}_{s}^{2} )}{{L}_{D}^{2}}} ] + {C}_{s} [ 1 - {e}^{- \frac{π {r}_{s}^{2}}{{L}_{D}^{2}}} ] \qquad ( 1 )$$

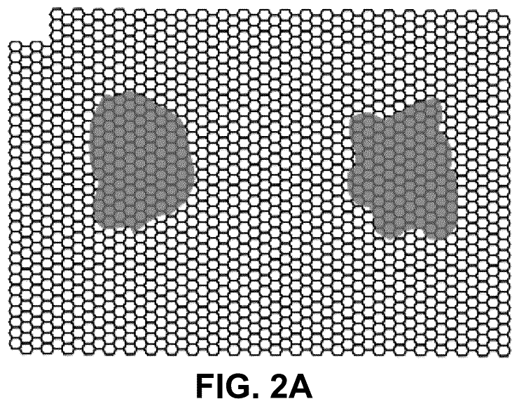

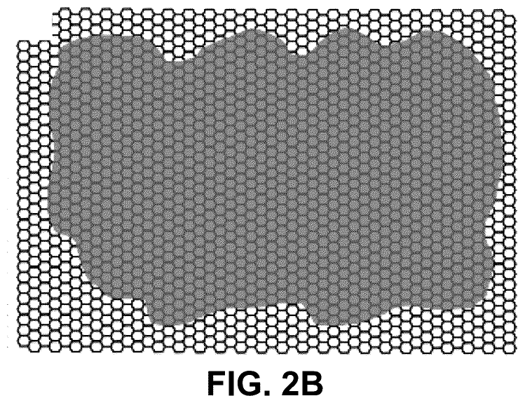

For L_{D}≥2rₐ, Equation (1) reduces to I_{D}/I_{G}∝1/L_{D}². In this regime, the active areas do not significantly overlap, and so I_{D}/I_{G} is proportional to σ=1/L_{D}², and increases with defect density. For L_{D≤}2rₛ, the disordered areas overlap with active areas, and the equation reduces to I_{D}/I_{G}→L_{D}², and so I_{D}/I_{G} decreases with defect density. One can also write Equation (1) as [5,30]:

$$\frac{{I}_{D}}{{I}_{G}} ( {L}_{D} ) = {C}_{a} {f}_{a} + {C}_{s} {f}_{s} \qquad ( 2 )$$

where fₐ and fₛ are the fractions of the sample's D-peak active and disordered areas. The solid curve shown in FIG. 1D is a plot of Equation (1) using Cₐ=2.56, Cₛ=0.03, rₐ=1.25 nm, and rₛ=0.88 nm. As the dosage initially increases I_{D}/I_{G} increases in good quantitative agreement with the model. At high dosages in which L_{D}≤2rₛ, I_{D}/I_{G} decreases with increasing dosage. From Equation (2), L_{D}=1.0 nm after the last dosage, and the active and disordered fractions are fₐ=0.08 and fₛ=0.91, respectively. The association of fₐ and fₛ as fractions of the entire area assumes that the whole area of the sample probed by the Raman laser was susceptible to becoming defective, as in the case of Ar ion bombardment. In the case of electron irradiation, however, only those sample areas initially containing adsorbed water vapor are susceptible to becoming defective. The higher the initial water coverage, the higher the maximum value of I_{D}/I_{G}, as illustrated in FIGS. 2A-2B. In FIGS. 2A-2B, it can be seen that after irradiation, I_{D}/I_{G} and the defect coverage are greater (FIG. 2B vs FIG. 2A). Therefore, in this case, fₐ and fₛ are associated with the fraction of the area initially containing adsorbed water. The result I_{D}/I_{G}=5.3 for graphene irradiation at near-atmospheric pressure shows that a significantly greater sample area becomes defective because more of the sample had adsorbed water. Without wishing to be bound by theory, this then implies that about 91% of the regions initially covered with water molecules have adsorbed hydrogen. If 100% of the graphene can be covered with adsorbed water molecules before irradiation, 91% hydrogenation across the entire sample could be achieved. By irradiating at atmospheric pressure, a sufficiently high initial coverage of adsorbed water may be reached, resulting in high hydrogen coverage suitable for hydrogen storage.

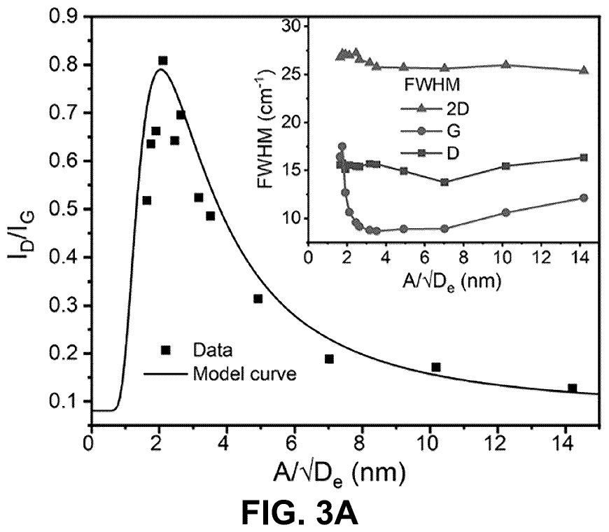

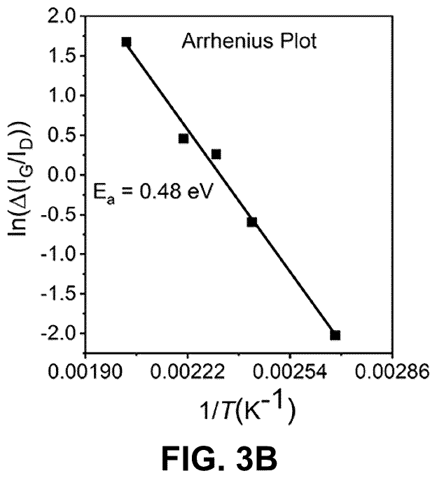

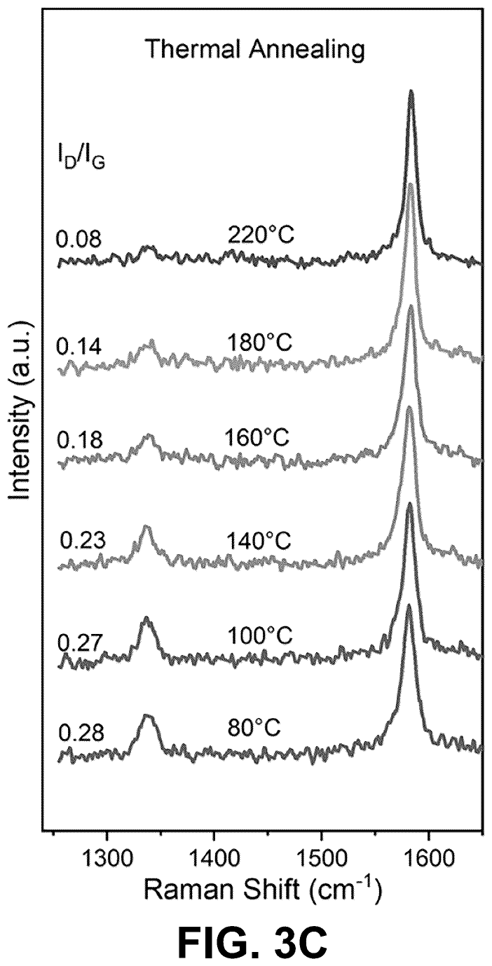

To learn more about the nature of the defects, the activation energy for defect healing, Eₐ, was measured using thermal annealing. In the sample shown in FIG. 1A, the final dosage was high, and the I_{D}/I_{G} ratio was low at 0.22, which made it difficult to detect changes in I_{D}/I_{G} during annealing. Therefore, a different sample was irradiated to a lower final dosage at which I_{D}/I_{G}=0.48. FIG. 3A shows a plot of I_{D}/I_{G} versus 100/√Dₑ for the sample. The solid squares are the experimental data points, and the solid curve is a fit using Equation (1) with parameters Cₐ=1.92, Cₛ=0.001, rₐ=1.62, and rₛ=1.15. In this case, the final fractions of active and disordered areas are fₐ=0.27 and fₛ=0.79, respectively. The inset in FIG. 3A shows the FWHM of the 2D, G, and D peaks. The FWHM of the G peak increases mainly in the second stage by about 6 cm⁻¹. As discussed in Ref. [24], the FWHM and position of all the peaks recover after annealing, supporting that the sample does not become amorphous.

The sample was annealed at various temperatures from 80-220° C. and Raman spectra were obtained after each anneal, as shown in FIG. 3B. The I_{D}/I_{G} ratio after each anneal is shown. After the last anneal at 220° C., the I_{D}/I_{G} ratio decreased significantly to 0.08, suggesting that the sample did not become amorphous in the second stage. As discussed in Ref [24], Eₐ was determined by approximating the annealed defect density as n∝I_{D}/I_{G}. An Arrhenius plot (FIG. 3C) was made from the annealing data in FIG. 3B by assuming a bimodal rate equation of the form:

$$dn / dt = - C {n}^{2} {e}^{{(}^{{E}_{a}} {/}_{{k}_{B} T} )} , \qquad ( 3 )$$

where C is a constant, T is the annealing temperature, k_{B} is Boltzmann's constant, and Eₐ is the activation energy for healing. A bimodal rate equation involves two similar reactants, such as what occurs in hydrogen desorption as H₂. This model was used in Ref. [36] to determine the activation energy for healing vacancies in Ar-ion bombarded graphene, where the reactants were carbon adatoms and vacancies. After integrating the rate equation, the following is obtained: for an annealing period of duration

$$Δ t = {t}_{2} - {t}_{1} , that 1 / {n}_{2} - 1 / {n}_{1} = Δ {tCe}^{( - {E}_{a} {/}_{{k}_{B} T} )} ,$$

where the subscripts denote subsequent anneals. Using n∝I_{D}/I_{G}, the following is obtained: ln[(I_{G}/I_{D})₂−(I_{G}/I_{D})₁]=ln(Δt)+ln(C)−(Eₐ/k_{B}T). In FIG. 3C, the solid squares are a plot of the experimental data using this equation. The solid straight line is a least-squares fit to the data with a slope Eₐ=0.48 eV. In contrast, the measured activation energy for healing vacancies in graphene produced by Ar ion bombardment is 0.95 eV [36]. The computed migration barriers for hydrogen and hydroxyl groups with attached water molecules are 0.29 and 0.58 eV, respectively [38], closer to the measured Eₐ. Ref. [24] also presented plots of the FWHM and peak positions of the D, G, and 2D Raman peaks versus dosage and annealing temperature. Slight increases in FWHM and recovery of the FWHM were found after annealing. It could be concluded that the graphene does not become amorphous in the second stage, as in the case of Ar ion bombardment, and that the defects formed by irradiation are hydrogen or hydroxyl adsorbates.

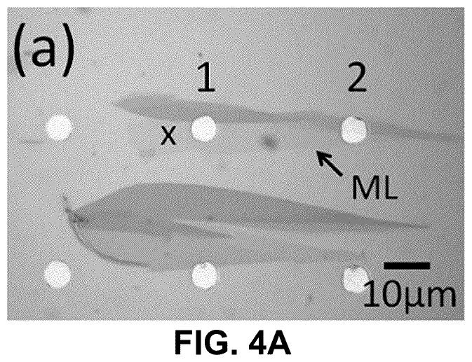

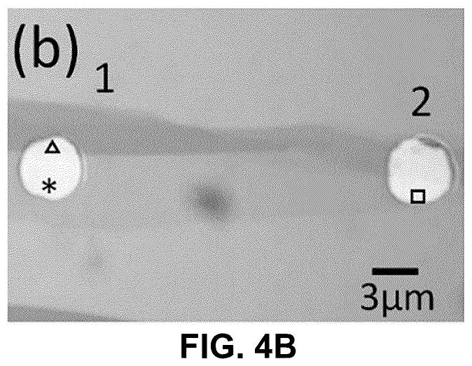

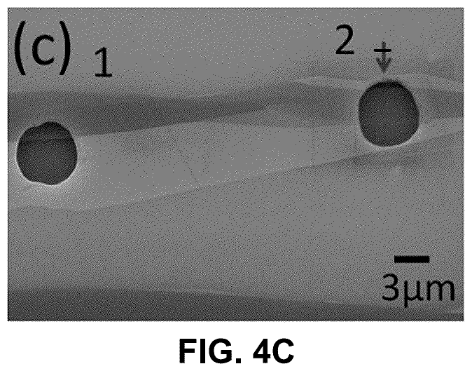

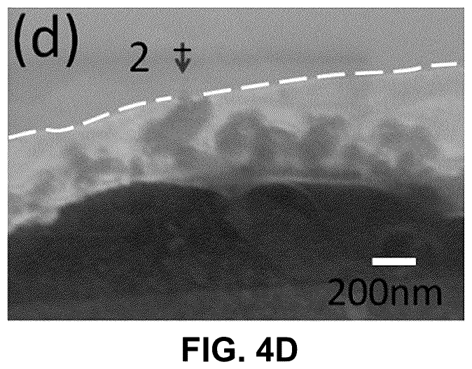

Electron Irradiation at Near-Atmospheric Pressure. Graphene drums in which graphene-sealed holes contain air at near-atmospheric pressure were irradiated. Graphene was mechanically exfoliated in the air under STP conditions onto SiO₂/Si substrates having etched holes, as shown in FIGS. 4A-4D. The holes were fabricated using photolithography and reactive ion etching (RIE), and are approximately 4 μm in diameter, 500 nm deep, and have centers spaced 25 μm apart in a square pattern. In the optical images shown in FIGS. 4A-4B, the holes appear as yellow circles, and in the SEM images shown in FIGS. 4C-4D, they appear as dark circles. The substrates were placed in an SEM system and the samples irradiated within an hour. The irradiation was at an electron energy of 20 keV to a dosage of 2.4×10¹⁷ electrons/cm² (e⁻/cm²).

Graphene drums that completely seal the hole leak only small quantities of the air inside the hole when one atmosphere of pressure exists across the graphene [18]. The graphene is mainly impermeable to the air, and the leakage occurs around the borders. If the air in the hole is an ideal gas, the leak rate is about 2×10³ atoms/s [18]. In the drums, the holes have a slightly smaller perimeter than in Ref. and should leak less. Assuming the air leak rate of the covered holes is the same as that of the holes in Ref. [18], then about 7.2×10⁶ atoms would leak out of the drums in an hour when the substrate is in a vacuum. The air density at STP is about 2.7×10¹⁹ molecules/cm³, so a hole in the substrate contains approximately 1.7×10⁸ molecules before being placed in the SEM system. After an hour in a vacuum, the number of molecules in the hole is (1.7×10⁸)−(7.2×10⁶)=1.63×10⁸, only a 4.2% decrease. Therefore, the pressure inside the hole after an hour in a vacuum is about 0.96 atmospheres.

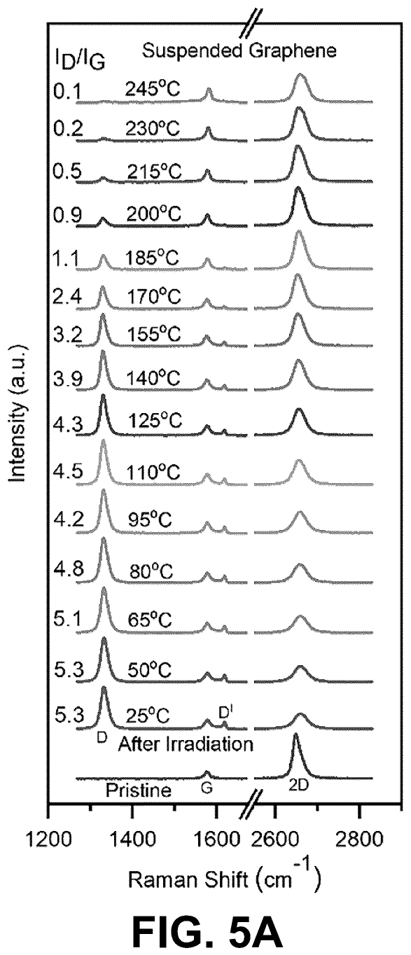

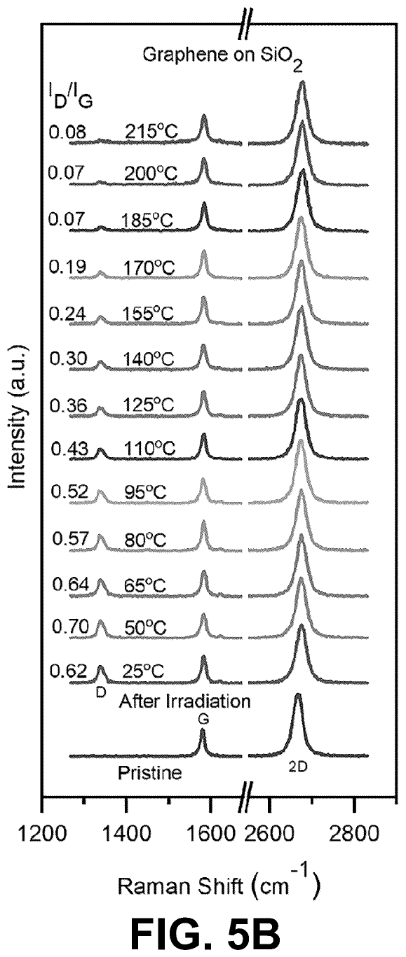

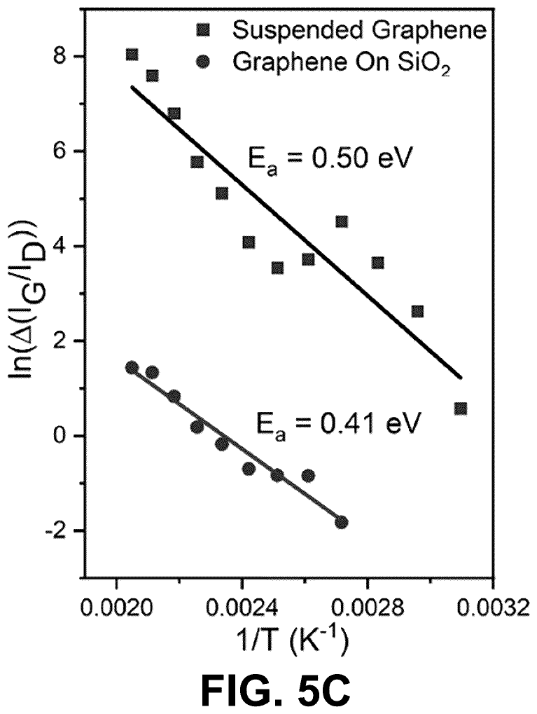

FIGS. 5A-5B show Raman spectra of the exfoliated flake of FIGS. 4A-4D acquired at the locations indicated by the “*” and “x”, corresponding to suspended and supported graphene, respectively. The “*” is on a monolayer part suspended over hole 1, and the “x” is on a monolayer part supported on the SiO₂ substrate. FIG. 5A shows that the suspended monolayer has an I_{D}/I_{G}=5.3 after irradiation. In contrast, the monolayer supported on the SiO₂ has a significantly lower value after irradiation of I_{D}/I_{G}=0.62, as shown in FIG. 5B. The high value of I_{D}/I_{G} for the suspended monolayer can be attributed to the nearly one atmosphere of air pressure inside the hole that produces a high density of adsorbed water on the side of the graphene facing the hole. The non-zero value of I_{D}/I_{G} for the monolayer region over the SiO₂ substrate can be attributed to adsorbed water between the monolayer and SiO₂ substrate.

FIGS. 5A-5B show the Raman spectra after annealing the sample for 5 minutes in N₂ gas at the temperatures specified in the figure. Using the same Arrhenius plot analysis described in the previous section, activation energies of Eₐ=0.50 eV for the suspended graphene and Eₐ=0.41 eV for the supported graphene are obtained (FIG. 5C). The differences in activation energies may be due to substrate interactions. The Arrhenius plot for the supported sample is fit well by a straight line, and the activation energy is within about 17% of the result in Ref. [24] for supported graphene. The Arrhenius plot for the suspended graphene is not as linear, possibly because of the high defect density that may result in interactions that are not bimodal.

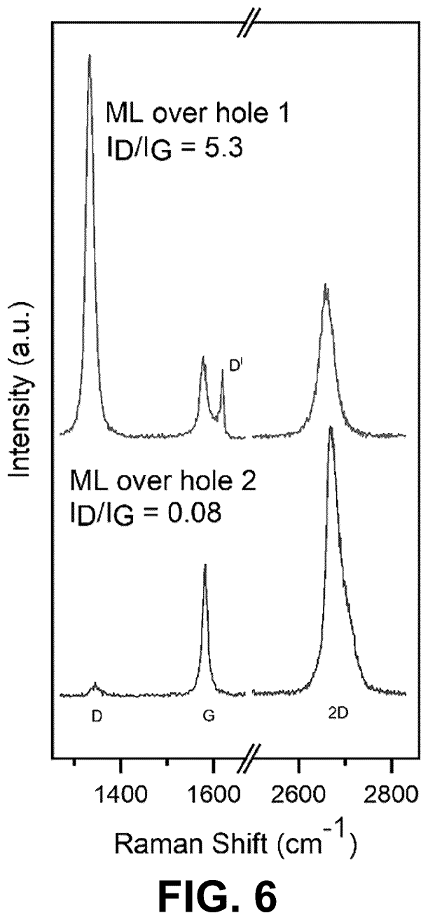

As shown in FIG. 6, a suspended monolayer region over hole 2 was irradiated, which, as discussed below, has a vacuum inside. From Raman spectra taken at the location of the “□” in FIG. 4B, a significantly lower I_{D}/I_{G} ratio of 0.08 is found. A closer inspection of hole 2, shows a channel etched into the SiO₂ with dimensions of about 200 nm, as shown in FIG. 4D. This channel connects the hole with the vacuum outside the graphene, as indicated by the cross-base arrows in FIGS. 4C and 4D, allowing air to exit the hole when the substrate is in a vacuum. This result is consistent with the hypothesis that a high initial adsorbed water density exists at near-atmospheric pressure and is responsible for the high I_{D}/I_{G} since fewer adsorbed water molecules would exist in a vacuum.

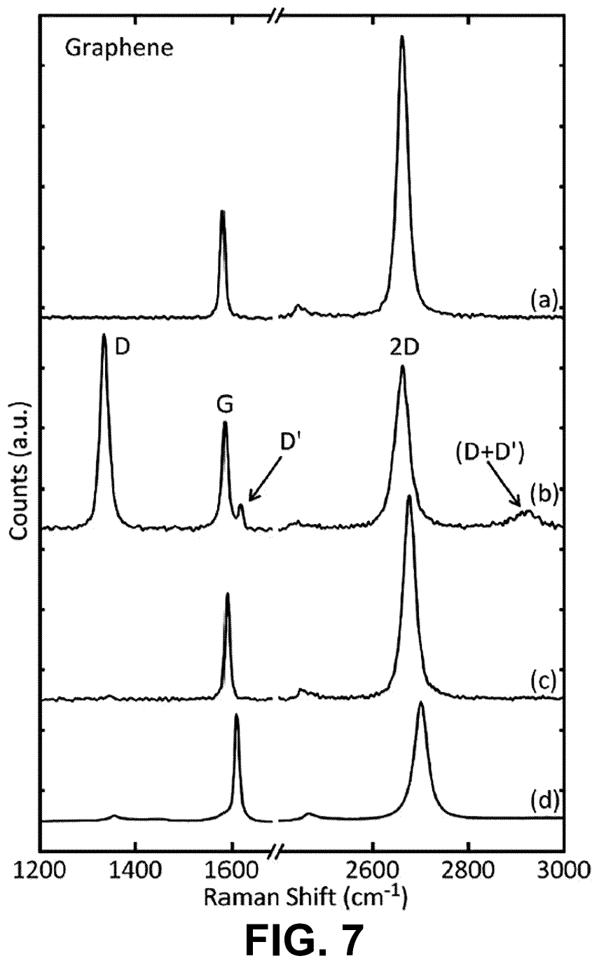

Electron-Induced Hydrogenation. In regard to the electron irradiation of graphene on solid SiO₂/Si substrates in a vacuum, it was found that electron irradiation at 30 keV to a dosage of 5.2×10¹⁷ e⁻/cm² using an SEM system resulted in a sharp D peak that almost completely disappeared after annealing the graphene at 270° C. for 30 min, as shown in FIG. 7, spectra (a)-(c) taken from Ref. [7]. The D peak can be attributed to hydrogenation because the D peak in graphene due to adsorbed hydrogen almost disappears after annealing the sample at 100-200° C. [15]. It is also observed that when the graphene was heated at 590° C. for 1 h in UHV to remove adsorbates and then irradiated, a D peak did not appear, as shown in FIG. 7, spectrum (d). Without wishing to be bound by theory, it is proposed that the hydrogenation is due to the electron-induced dissociation of adsorbed water on the graphene.

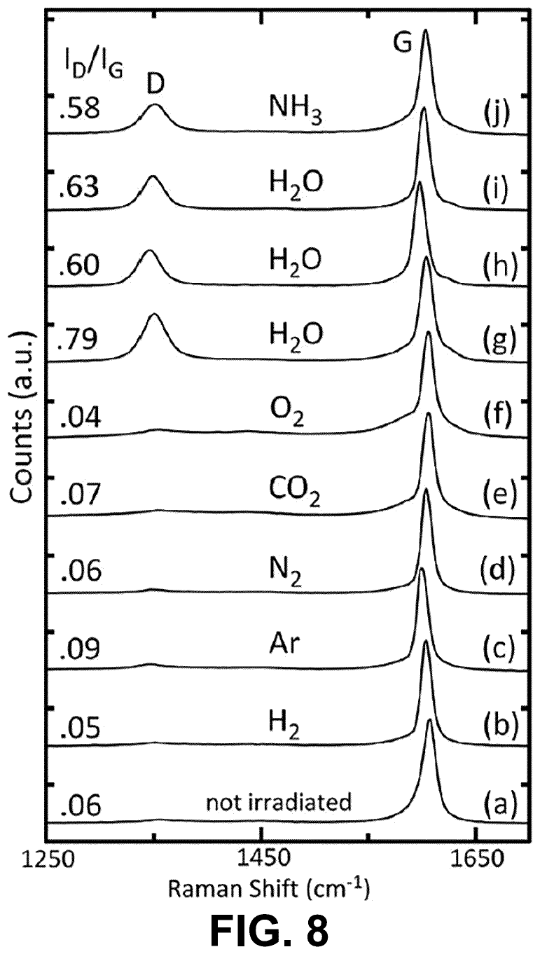

This explanation for the D-peak formation mechanism in terms of hydrogenation differs from the mechanism proposed in Refs. [3,28]. These authors attribute the D peak to the amorphization of the graphene lattice. To investigate the D-peak formation mechanism in more detail, UHV experiments were performed using a UHV-compatible sample preparation chamber attached to a UHV characterization chamber, the same system proposed to use for the UHV experiments. Samples could be transferred from the preparation to the characterization chamber using linear translators without exposing the samples to air. Graphene was heated at 590° C. in the UHV chamber to remove adsorbates, then the graphene was transferred to the preparation chamber and exposed to ultra-pure H₂, Ar, N₂, CO₂, O₂, H₂O, and NH₃ gases [8]. H₂ molecules do not adsorb on graphene at room temperature, while H₂O and NH₃ molecules adsorb. The sample was then transferred to the UHV chamber and irradiated to a dosage of 1.2-2.9 mC/cm² (0.75−1.8×10¹⁶ e⁻/cm²) at 5 keV using an electron gun. FIG. 8 from Ref. [8] shows the resulting Raman spectra. The irradiation dosage is 1.2 mC/cm², except for spectrum (i) that is 2.9 mC/cm². Spectrum (a) is only heated, spectrums (b)-(g) and (j) were exposed to the indicated gas at 1 torr for 1 h, and spectrums (h) and (i) were exposed to the indicated gas at 17 torr for 1 h. As shown in FIG. 8, spectrum (a), after heating in UHV, a small D peak with I_{D}/I_{G}=0.06 was observed. As shown in FIG. 8, spectra (b)-(g), exposing the samples to H₂, Ar, N₂, CO₂, and O₂ resulted in I_{D}/I_{G} values ranging from 0.04-0.09, in the range of 0.06 for the unirradiated sample shown in FIG. 8, spectrum (a). In contrast, the samples exposed to H₂O and NH₃ had I_{D}/I_{G}=0.79, 0.60, 0.63, and 0.58, as shown in FIG. 8, spectra (g), (h), (i) and (j), respectively.

These experiments provide evidence for the dissociation mechanism. As discussed in Ref. [8], it can be proposed that the dissociation of H₂O and NH₃ is due to secondary electrons emitted from the SiO₂ substrate due to the incident high-energy electrons. The cross-section for dissociation into H⁺ ions and hydrogen radicals as a function of electron energy has a broad maximum at about 100 eV that ranges from about 30 eV to 1 keV. Incident electrons at energies >1 keV do not produce much dissociation. However, secondary electrons, which typically have a broad energy distribution with a maximum at about 50 eV, will have a high probability of dissociating H₂O and NH₃. For H₂O, the maximum cross-section for dissociation is σ_{M}=1-3×10⁻¹⁷ cm². As discussed in Ref. [8], the probability, P, that a molecule with cross-section o dissociates after irradiation with N electrons is PP=(1−ee^{-NNNN}). If it is assumed that each incident electron produces one secondary electron that interacts with a cross-section of OM, then for a dosage of 3 mC/cm², N=2×10¹⁶/cm² and P=0.45. This approximate calculation shows that a high percentage of the H₂O and NH₃ adsorbates dissociate at these irradiation dosages.

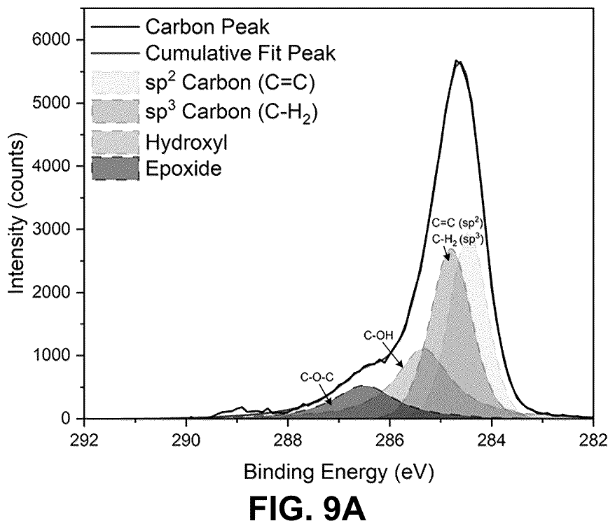

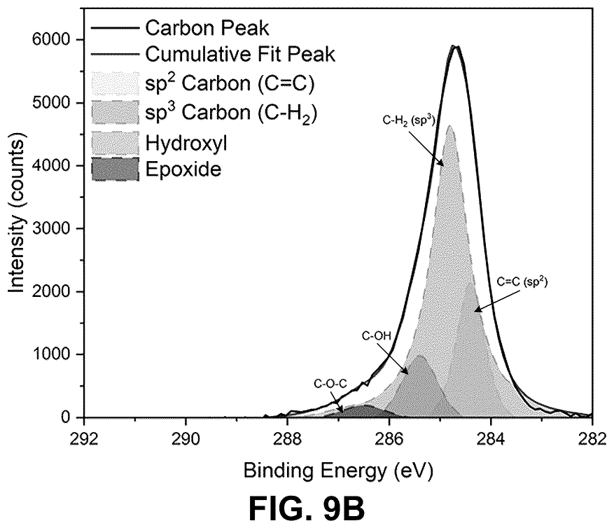

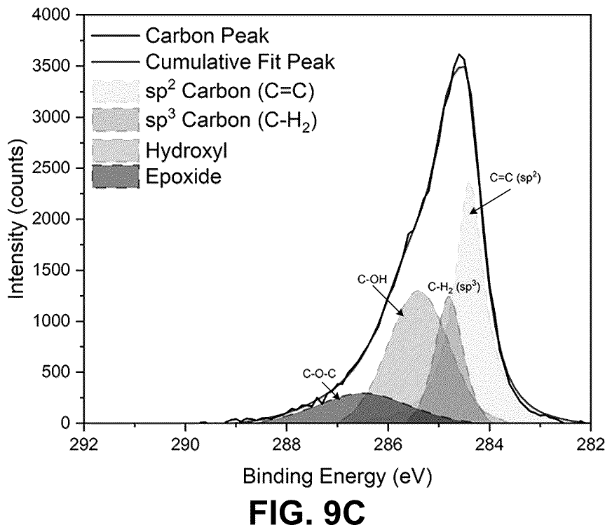

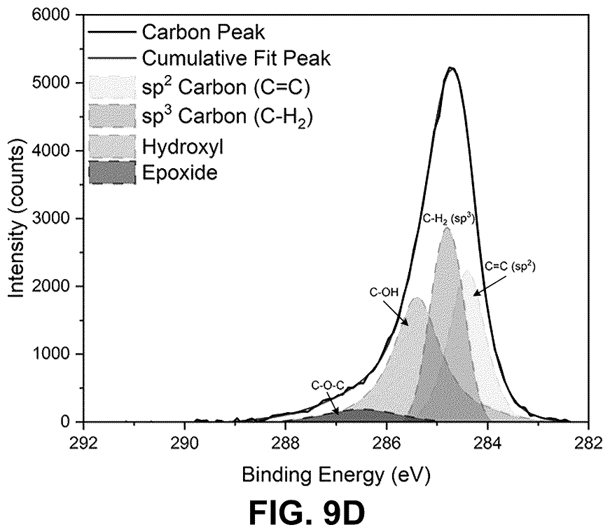

Irradiated CVD grown graphene samples have undergone preliminary studies using XPS. XPS is more sensitive than Raman to the type of element adsorbed on a surface. Samples are irradiated in UHV conditions to avoid the forming of carbonaceous film that could interfere with the accuracy of XPS studies. Adsorbates can be identified from the shifts they induce in the carbon peak. For example, C—H₂, C—OH, C—O, and C═O bonds cause different changes in the carbon peak position. The hydrogen and oxygen coverages are estimated from the relative heights of the deconvolved peaks [6]. The XPS results corroborate the other techniques' findings of hydrogenation. FIG. 9A shows the C1s spectrum for a pristine CVD graphene sample. The asymmetry toward higher binding energies is indicative of graphene with low density of sp³-type defects having C—H₂ bonds and therefore not hydrogenated [39]. FIG. 9B shows the C1s peak for the same sample after electron irradiation. The symmetry is indicative of graphene with a high density of C—H₂ bonds indicating hydrogenation [39]. Deconvolution of the spectra clearly indicates a peak at binding energies associated with hydrogenated graphene. FIG. 9C shows the spectrum for the same sample after annealing at 270° C. At this temperature hydrogen is expected to desorb from the graphene. The peak returns to an asymmetric shape and deconvolution shows a significantly decreased C—H₂ peak indicating loss of hydrogenation. FIG. 9D shows the spectrum for the same sample after a second irradiation, showing once again a C—H₂ peak due to hydrogenation, indicating that the hydrogenation by electron irradiation is reversable and repeatable. This further confirms hydrogenation of the graphene.

### G. EXAMPLE 2—PROPHETIC

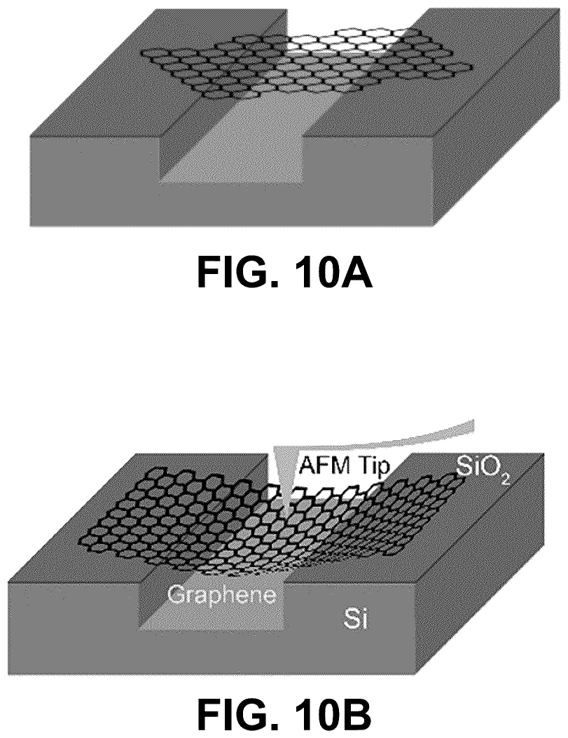

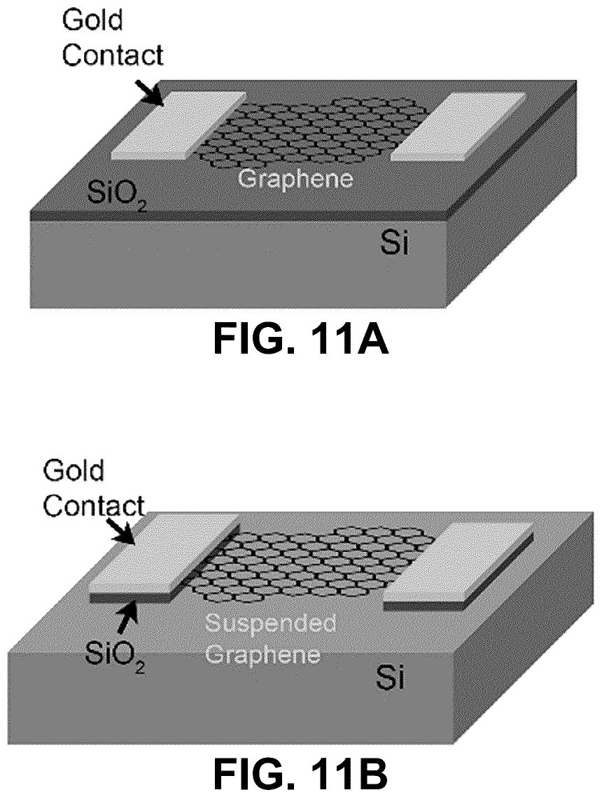

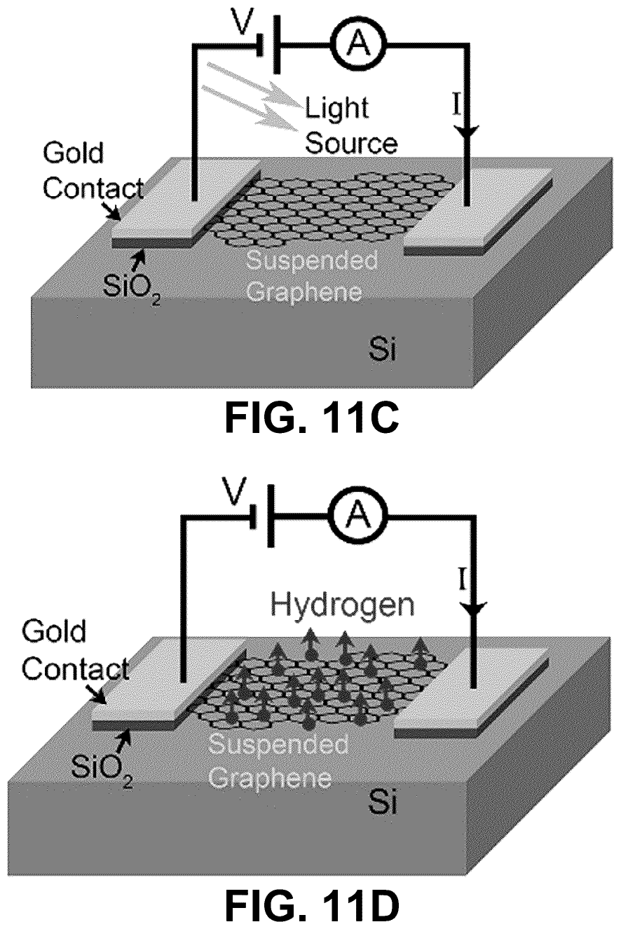

Fabrication and Irradiation of Suspended Graphene Samples. Suspended samples using both exfoliated and CVD-grown graphene will be fabricated. The CVD-grown graphene will be transferred from Cu substrates. Exfoliated graphene is primarily defect-free, but the size is on the order of only 20 to 40 μm in the lateral dimension, making STM and mass spectroscopy challenging. CVD-grown graphene can be 1 cm in the lateral dimension but contains grain boundaries that may affect the interpretation of desorption results. The crystallite size in the CVD-grown films is similar to an exfoliated flake so CVD-grown graphene will work for STM imaging and STS; the large size will make mounting, contacting, and locating the sample in the STM system easier. Graphene grown on SiC substrates will also be used for the STM experiments; various authors have used these graphene films to study hydrogen adsorption on graphene at room temperature with excellent results [9,11,12]. Suspended graphene samples will be fabricated over trenches about 5 μm in width and several hundred nanometers deep etched into the SiO₂/Si substrate. Two types will be manufactured: with and without electrical contacts. Graphene samples without electrical leads will be made by exfoliating or transferring graphene over pre-existing channels etched into the SiO₂ using EBL and RIE, as shown in FIG. 10A. These samples are easy to make and suitable for Raman and mechanical measurements using AFM, as shown in FIG. 10B. Suspended samples will be fabricated with electrical leads using the standard BOE dip method [40], outlined in FIGS. 11A-11D. The graphene will be exfoliated or transferred onto a SiO₂/Si substrate, gold contacts fabricated using EBL, and the sample dipped in BOE, which removes the SiO₂, including the SiO₂ under the graphene. The gold contacts act as a mask preventing the SiO₂ under them from etching. Contacted samples will be used for high-specificity mass spectroscopy and electrical and optical measurements.

The graphene samples will be irradiated in the ESEM at 20 Torr of heavy water vapor with the graphene cooled to increase the adsorbate density to that at atmospheric pressure. The density of adsorbed heavy water will be increased past that at atmospheric pressure by cooling to lower temperatures to see if I_{D}/I_{G} increases. The irradiated graphene samples will be studied using mass spectroscopy in situ in the ESEM chamber.

Identification of Defects and Coverages Using STM, Mass Spectroscopy, Raman Spectroscopy, and XPS. STM will be used to detect adsorbed hydrogen. Large-area CVD-grown graphene films transferred onto SiO₂ substrates and graphene grown on SiC will be investigated. The samples will be heated in UHV to clean them of contaminants, transferred to the preparation chamber for exposure to heavy water vapor, and moved back to the UHV chamber for electron irradiation. The dosing and irradiation procedures are similar to those used in previous reports [7,8]. The entire area of the graphene sample will be irradiated. The irradiated films will be studied using atomic resolution STM imaging and STS. Ref. [11] reported that chemisorbed hydrogen has a high corrugation height and induces a gap opening from 0.4 eV to 1.5 eV as measured using STS. For mass spectroscopy, samples will be irradiated in the ESEM to achieve high adsorbate coverage. In situ mass spectroscopy will be used in the ESEM to minimize surface contamination. Mass spectroscopy of the CVD films and films on SiC will be performed by heating the substrate in the UHV system. In the ESEM, the maximum irradiation area is about 100×100 um² due to the time required using beam currents of microamps. Therefore, large-area samples cannot be irradiated entirely in the ESEM. The number of desorbed deuterium species will be low and the outgassing high.

To increase the sensitivity, thermal desorption and mass spectroscopy of microscopic, suspended graphene samples will be performed by ohmically heating them using electrical contacts, as shown in FIG. 11D. Heating an individual graphene sample produces less outgassing from the surrounding area. The mass spectrometer can detect the desorbed species from a particular graphene sample. The minimum partial pressure detectable by a mass spectrometer with an electron multiplier is about 10⁻¹⁴ Torr. Based on the assumption that the size of the graphene sample exposed to electron irradiation is 60 μm², the partial pressure of desorbed deuterium from this area for fully deuterated graphene can be calculated as follows. The number of carbon atoms in 60 μm² of graphene is 2.3×10⁹. Graphane has the chemical formula CH; thus, the fully deuterated sample has 2.3×10⁹ hydrogen atoms. The ESEM chamber has a volume of about 5×10⁴ cm³. The ideal gas law can be used to find that the partial pressure of deuterium in the chamber would be 1.4×10⁻⁷ Torr. The base pressure of the ESEM is about 10⁻⁸ Torr with no mass four partial pressure. The amount of desorbed deuterium will be measured using the known cracking ratios of H₂ to H and D₂ to D in the mass spectrometer and the initial coverage from the irradiated area.

Raman spectroscopy will be used to measure the I_{D}/I_{G} ratio as a function of electron dosage. The two-stage model will be used to estimate the adsorbate coverage and the results compared with the mass spectroscopy measurements. Raman mapping of the Gpeak position and I_{D}/I_{D′} ratio will be used to characterize the adsorbates and defects. The physical adsorption of water molecules dopes graphene p-type by charge transfer—the G peak blue-shifts its position due to this doping [41]. The ratio I_{D}/I_{D′} can indicate the type of defect. It can be high for sp³-type defects, intermediate for vacancies, and low for boundaries [13]. Finally, the irradiated samples can be investigated using temperature programmed desorption (TPD) studies. CVD grown graphene samples will be used for their greater size so that the desorbed hydrogen is easier to detect. These samples will be annealed and then exposed to heavy water vapor so that the desorbed deuterium, D₂, can be differentiated from the hydrogen, H₂, from the surrounding environment by a mass spectrometer. This technique can allow for a more accurate and sensitive detection of hydrogenation.

Electrical, Optical, and Mechanical Properties, and Irradiation of Bulk Samples. The electrical conductivity and photoconductivity of irradiated suspended graphene samples (e.g., FIG. 11A) will be studied using the contacted graphene shown in FIG. 11C. The electrical conductivity and photoconductivity will be measured using two and four-contact techniques. For four contact measurements, an additional contact will be fabricated next to each one shown in FIG. 11B [40]. The photoconductivity measurements will utilize a variable wavelength light source to illuminate the sample while the current is measured, as shown in FIG. 11C. The onset of conductivity determines the photoconductive band gap. The mechanical properties of suspended graphene samples will be investigated using surface force measurements, as illustrated in FIG. 10B. Calculations predict graphane is about ⅓ as strong as graphene [42,43]. The AFM system has software to set the contact force and perform indentation and scratch measurements. These measurements will be used to determine irradiated versus unirradiated graphene's elastic modulus and breaking strength.

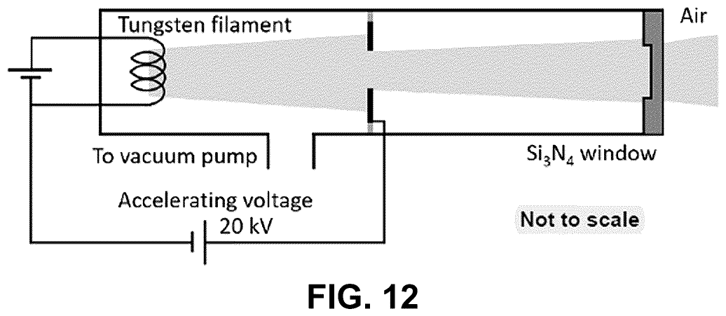

Using an electron accelerator, bulk graphene powder and graphene suspended on TEM grids will be irradiated with 20 keV electrons in ambient air at STP. An exemplary electron accelerator is shown in FIG. 12. It consists of a hot tungsten filament electron emitter, accelerating plates, and a 100 nm thick Si₃N₄ window with a square area of 4 mm² through which the electrons exit into the air. Bulk graphene powder will be irradiated to various dosages, characterize the samples using mass spectroscopy, Raman spectroscopy, and XPS, and compare the results with those obtained for suspended samples.

Many variations and modifications may be made to the above-described aspects. All such modifications and variations are intended to be included herein within the scope of this disclosure and protected by the following claims.

What is claimed:

1. A method for hydrogen storage comprising:
irradiating a graphene sample with electrons at energies of about 1 keV to about 40 keV at about 1 atm of pressure, thereby forming hydrogenated graphene.

2. The method of claim 1, wherein the graphene sample is irradiated at a temperature of about 0° C. to about 40° C.

3. The method of claim 1, wherein the graphene sample is irradiated in ambient air.

4. The method of claim 1, wherein the graphene sample is irradiated with electrons at energies of about 15 keV to about 25 keV.

5. The method of claim 1, wherein the graphene sample comprises at least one graphene layer deposited onto a support so that at least one surface of the graphene layer is exposed to air and a second surface of the graphene layer is at least partially in contact with the support.

6. The method of claim 5, wherein the support is a silicon substrate.

7. The method of claim 6, wherein the support is an SiO₂/Si substrate or a mica substrate.

8. The method of claim 5, wherein the support comprises at least one trench of about 1 μm to about 10 μm in width and about 100 nm to about 500 nm in depth and wherein the graphene layer is deposited over the trench so that at least part of the second surface of the graphene layer is exposed to air.

9. The method of claim 1, wherein the graphene sample comprises graphene powder.

10. The method of claim 9, wherein the graphene powder has a flake size of about 100 nm to about 10 μm.

11. The method of claim 1, wherein the hydrogenated graphene has an I_{D}/I_{G} ratio of greater than about 2.0 as measured by Raman spectroscopy.

12. A method for releasing stored hydrogen, comprising heating a hydrogenated graphene sample formed by the method claim 1 at a temperature of about 240° C. to about 300° C.

13. A system for hydrogenating graphene, comprising a graphene sample and an electron accelerator configured to irradiate the graphene sample with electrons in ambient air at about 1 atm of pressure.

14. The system of claim 13, wherein the graphene sample is kept at a temperature of about 0° C. to about 40° C.

15. The system of claim 13, wherein the graphene sample comprises at least one layer of graphene deposited on a support so that at least one surface of the graphene layer is exposed to air and a second surface of the graphene layer is at least partially in contact with the support.

16. The system of claim 15, wherein the support is a silicon substrate.

17. The system of claim 16, wherein the support is an SiO₂/Si substrate or a mica substrate.

18. The system of claim 15, wherein the support comprises at least one trench of about 1 μm to about 10 μm in width and about 100 nm to about 500 nm in depth and wherein the graphene layer is deposited over the trench so that at least part of the second surface of the graphene sample is exposed to air.

19. The system of claim 13, wherein the graphene sample comprises graphene powder.

20. A composition comprising graphene hydrogenated by the method of claim 1.
